(19) United States
(12) Patent Application Publication
(10) Pub. No.: US 2017/0163980 A1
(43) Pub. Date: Jun. 8, 2017

(54) INFORMATION PROCESSING DEVICE AND METHOD

(71) Applicant: SONY CORPORATION, Tokyo (JP)

(72) Inventors: Mitsuhiro HIRABAYASHI, Tokyo (JP); Ohji NAKAGAMI, Tokyo (JP)

(73) Assignee: SONY CORPORATION, Tokyo (JP)

(21) Appl. No.: 15/309,963

(22) PCT Filed: Jun. 16, 2015
(86) PCT No.: PCT/JP2015/067232

§ 371 Date: Nov. 9, 2016

(30) Foreign Application Priority Data
Jun. 30, 2014 (JP) 2014-135146

(51) Int. Cl. H04N 19/102; H04N 21/462; H04N 19/189; H04N 19/136; H04N 19/169

(52) U.S. Cl. CPC H04N 19/102; H04N 19/136; H04N 19/169; H04N 19/189; H04N 21/4621; H04N 21/4622

(57) ABSTRACT

The present technology relates to an information processing device and method which can control decoding time of encoded data obtained by hierarchically encoding a multi-layered image. The information processing device according to the present technology generates a file storing encoded still image data obtained by encoding still images, and encoded moving image data obtained by encoding a moving image using prediction with reference to still images, in different tracks, sets time information specifying decoding time of frames, in a track of the file storing the encoded moving image data, and sets time information specifying decoding time of the still images, in a track of the file storing the encoded still image data, on the basis of a reference relationship between the still images and the moving image for the prediction, using the time information of the encoded moving image data. The present technology can be applied to, for example, an information processing device, an image processing device, an image encoding device, an image decoding device, or the like.

### TECHNICAL FIELD

The present technology relates to an information processing device and method, and particularly relates to an information processing device and method which can control decoding time of encoded data obtained by hierarchically encoding a multi-layered image.

### BACKGROUND ART

Conventionally, various methods have been proposed as an image encoding/decoding method. For example, hierarchical encoding or the like has been devised for efficiently encoding a multi-layered image using prediction between layers, or the like. Such a layered image is designed, for example, to perform prediction in which still images are defined as a base layer, a moving image is defined as an enhancement layer, and the moving image is encoded with reference to the still images.

Incidentally, as a technology for distributing content such as image data, there is moving picture experts group-dynamic adaptive streaming over HTTP (MPEG-DASH) (e.g., see Non-Patent Document 1). In MPEG-DASH, a bit stream of image data encoded by a predetermined encoding method is stored in a file having a predetermined file format such as an MP4 file format, and then distributed.

### CITATION LIST

### Non-Patent Document

Non-Patent Document 1: MPEG-DASH (Dynamic Adaptive Streaming over HTTP)(URL:http://mpeg.chiariglione.org/standards/mpeg-dash/media-presentation-description-and-segment-formats/text-isoiec-23009-12012-dam-1)

### SUMMARY OF THE INVENTION

### Problems to be Solved by the Invention

Incidentally, as described above, when encoded moving image data hierarchically encoded is decoded, it is necessary to refer to decoded still images. Accordingly, data distribution (in particular, streaming), such as the MPEG-DASH, needs to timely decode the still images.

However, the still image has no concept of time, and it is difficult to control decoding time of encoded still image data. In addition, a conventional file format such as MP4 file format used for such data distribution can only perform timing control based on one timeline, and has no function of appropriately controlling the decoding time of the encoded data obtained by hierarchically encoding data of the still image having no concept of time and the moving image having the concept of time.

The present technology has been proposed in view of such circumstances, and it is an object of the present technology to control decoding time of encoded data obtained by hierarchically encoding a multi-layered image.

### Solutions to Problems

According to one aspect of the present technology, there is provided an information processing device including a file generation unit and a time information setting unit. The file generation unit generates a file storing encoded still image data obtained by encoding still images, and encoded moving image data obtained by encoding a moving image using prediction with reference to the still images, in different tracks, and the time information setting unit sets time information specifying decoding time of frames in a track of the file storing the encoded moving image data, and setting time information specifying decoding time of the still images, in a track storing the encoded still image data of the file, on the basis of a reference relationship between the still images and the moving image for the prediction, using the time information of the encoded moving image data.

The file generation unit can store, in the file, information indicating a storage location of the encoded still image data, instead of the encoded still image data.

In addition, according to one aspect of the present technology, there is provided an information processing method including the steps of generating a file storing encoded still image data obtained by encoding still images, and encoded moving image data obtained by encoding a moving image using prediction with reference to the still images, in different tracks, setting time information specifying decoding time of frames in a track of the file storing the encoded moving image data, and setting time information specifying decoding time of the still images, in a track storing the encoded still image data of the file, on the basis of a reference relationship between the still images and the moving image for the prediction, using the time information of the encoded moving image data.

According to another aspect of the present technology, there is provided an information processing device including a file reproduction unit, a still image decoding unit, and a moving image decoding unit. The file reproduction unit reproduces a file storing encoded still image data obtained by encoding still images, and encoded moving image data obtained by encoding a moving image using prediction with reference to the still images, in different tracks, and extracts the encoded still image data and the encoded moving image data, and the still image decoding unit timely decodes the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction, and the moving image decoding unit decodes the encoded moving image data extracted from the file timely on the basis of the time information specifying decoding time of frames of the encoded moving image data, with reference to the still images obtained by decoding the encoded still image data.

In addition, according to still another aspect of the present technology, there is provided an information processing method including the steps of reproducing a file storing encoded still image data obtained by encoding still images, and encoded moving image data obtained by encoding a moving image using prediction with reference to the still images, in different tracks, and extracting the encoded still image data and the encoded moving image data, timely decoding the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction, and timely decoding the encoded moving image data extracted from the file, on the basis of the time information specifying decoding time of frames of the encoded moving image data, with reference to the still images obtained by decoding the encoded still image data.

According to still another aspect of the present technology, there is provided an information processing device including a file generation unit and a table information generation unit. The file generation unit generates a file storing encoded still image data obtained by encoding still images, and encoded moving image data obtained by encoding a moving image using prediction with reference to the still images, in different tracks, and the table information generation unit generates table information representing a reference relationship between the still images and the moving image for the prediction, and stores the table information in the file.

The file generation unit can store time information indicating display time of the still image, in the file.

According to still further another aspect of the present technology, an information processing method includes the steps of generating a file storing encoded still image data obtained by encoding still images, and encoded moving image data obtained by encoding a moving image using prediction with reference to the still images, in different tracks, and generating table information representing a reference relationship between the still images and the moving image for the prediction, and storing the table information in the file.

According to still another aspect of the present technology, there is provided an information processing device including a file reproduction unit, a still image decoding unit, and a moving image decoding unit. The file reproduction unit reproduces a file storing encoded still image data obtained by encoding still images, and encoded moving image data obtained by encoding a moving image using prediction with reference to the still images, in different tracks, and extracts the encoded still image data and the encoded moving image data, the still image decoding unit timely decodes the encoded still image data extracted from the file, on the basis of time information specifying decoding time of frames of the encoded moving image data, and table information representing a reference relationship between the still images and the moving image for the prediction, and the moving image decoding unit timely decodes frames of the encoded moving image data extracted from the file, on the basis of the time information, with reference to the still images obtained by decoding the encoded still image data by the still image decoding unit.

In addition, according to still further another aspect of the present technology, an information processing method includes the steps of reproducing a file storing encoded still image data obtained by encoding still images, and encoded moving image data obtained by encoding a moving image using prediction with reference to the still images, in different tracks, extracting the encoded still image data and the encoded moving image data, timely decoding the encoded still image data extracted from the file, on the basis of time information specifying decoding time of frames of the encoded moving image data, and table information representing a reference relationship between the still images and the moving image for the prediction, and timely decoding frames of the encoded moving image data extracted from the file, on the basis of the time information, with reference to the still images obtained by decoding the encoded still image data by the still image decoding unit.

According to still another aspect of the present technology, there is provided an information processing device including a time information generation unit and a metadata generation unit. The time information generation unit generates time information indicating decoding time of encoded still image data obtained by encoding still images, and time information indicating decoding time of frames of encoded moving image data obtained by encoding a moving image using prediction with reference to the still images, using a predetermined timeline, and the metadata generation unit generates metadata used for providing the encoded still image data and the encoded moving image data, using the time information.

In addition, according to still further another aspect of the present technology, there is provided an information processing method including the steps of generating time information indicating decoding time of encoded still image data obtained by encoding still images, and time information indicating decoding time of frames of encoded moving image data obtained by encoding a moving image using prediction with reference to the still images, using a predetermined timeline, and generating metadata used for providing the encoded still image data and the encoded moving image data, using the time information.

According to one aspect of the present technology, a file is generated which stores, in different tracks, encoded still image data obtained by encoding still images, and encoded moving image data obtained by encoding a moving image using prediction with reference to the still images, time information specifying decoding time of frames is set in a track of the file storing the encoded moving image data, and time information specifying decoding time of the still images is set in a track of the file storing the encoded still image data, on the basis of a reference relationship between the still images and the moving image for the prediction, using the time information of the encoded moving image data.

According to another aspect of the present technology, a file is reproduced which stores, in different tracks, encoded still image data obtained by encoding still images, and encoded moving image data obtained by encoding a moving image using prediction with reference to the still images, the encoded still image data and the encoded moving image data are extracted, the encoded still image data extracted from the file is timely decoded on the basis of time information specifying decoding time of the still images set using time information specifying decoding time of frames of the encoded moving image data on the basis of a reference relationship between the still images and the moving image for the prediction, and the encoded moving image data extracted from the file is timely decoded on the basis of time information specifying decoding time of frames of the encoded moving image data, with reference to the still images obtained by decoding the encoded still image data.

According to still another aspect of the present technology, a file is generated which stores, in different tracks, encoded still image data obtained by encoding still images and encoded moving image data obtained by encoding a moving image using prediction with reference to the still images, and table information representing a reference relationship between the still images and the moving image for the prediction is generated, and stored in the file.

According to still another aspect of the present technology, a file is reproduced which stores, in different tracks, encoded still image data obtained by encoding still images, and encoded moving image data obtained by encoding a moving image using prediction with reference to the still images, the encoded still image data and the encoded moving image data are extracted, the encoded still image data extracted from the file is timely decoded on the basis of time information specifying decoding time of frames of the encoded moving image data, and table information representing a reference relationship between the still images and the moving image for the prediction, and the frames of the encoded moving image data extracted from the file are timely decoded on the basis of the time information, with reference to the still images obtained by decoding the encoded still image data by a still image decoding unit.

According to still another aspect of the present technology, time information indicating decoding time of encoded still image data obtained by encoding still images, and time information indicating decoding time of frames of encoded moving image data obtained by encoding a moving image using prediction with reference to the still images are generated using a predetermined timeline, and metadata is generated which is used for providing the encoded still image data and the encoded moving image data, using the time information.

### Effects of the Invention

According to the present technology, information can be processed. Furthermore, according to the present technology, decoding time of the encoded data obtained by hierarchically encoding a multi-layered image can be controlled.

### BRIEF DESCRIPTION OF DRAWINGS

FIG. 1 is a diagram illustrating an exemplary configuration of an MP4 file format.

FIG. 2 is a diagram illustrating an exemplary main configuration of an MP4 file.

FIG. 3 is a block diagram illustrating an exemplary main configuration of an MP4 file generation device.

FIG. 4 is a flowchart illustrating an example of a flow of an MP4 file generation process.

FIG. 5 is a block diagram illustrating an exemplary main configuration of an MP4 file reproduction device.

FIG. 6 is a flowchart illustrating an example of a flow of an MP4 file reproduction process.

FIG. 7 is a diagram illustrating an exemplary main configuration of an MP4 file.

FIG. 8 is a diagram illustrating an example of a syntax of a base layer POC sample entry.

FIG. 9 is a block diagram illustrating an exemplary main configuration of an MP4 file generation device.

FIG. 10 is a flowchart illustrating an example of a flow of an MP4 file generation process.

FIG. 11 is a block diagram illustrating an exemplary main configuration of an MP4 file reproduction device.

FIG. 12 is a flowchart illustrating an example of a flow of an MP4 file reproduction process.

FIG. 13 is a diagram illustrating an exemplary main configuration of an MP4 file.

FIG. 14 is a block diagram illustrating an exemplary main configuration of an MP4 file generation device.

FIG. 15 is a flowchart illustrating an example of a flow of an MP4 file generation process.

FIG. 16 is a block diagram illustrating an exemplary main configuration of an MP4 file reproduction device.

FIG. 17 is a flowchart illustrating an example of a flow of an MP4 file reproduction process.

FIG. 18 is a diagram illustrating an exemplary configuration of an MPD.

FIG. 19 is a diagram illustrating an example of correction information.

FIG. 20 is a diagram illustrating an example of correction information.

FIG. 21 is a diagram illustrating an example of correction information.

FIG. 22 is a diagram illustrating an exemplary main configuration of an MP4 file.

FIG. 23 is a diagram illustrating an exemplary configuration of an MPD.

FIG. 24 is a diagram illustrating an exemplary configuration of an MPD.

FIG. 25 is a block diagram illustrating an exemplary main configuration of a file generation device.

FIG. 26 is a flowchart illustrating an example of a flow of a file generation process.

FIG. 27 is a block diagram illustrating an exemplary main configuration of a file reproduction device.

FIG. 28 is a flowchart illustrating an example of a flow of a file reproduction process.

FIG. 29 is a block diagram illustrating an exemplary main configuration of a distribution system.

FIG. 30 is a block diagram illustrating an exemplary main configuration of a computer.

### MODE FOR CARRYING OUT THE INVENTION

A mode for carrying out the present disclosure (hereinafter, referred to as embodiment) will be described below. It is to be noted that description will be made in the following order.
1. First embodiment (use of DTS of MP4)
2. Second embodiment (generation and use of POC reference table)

3. Third embodiment (independent still images)

4. Fourth embodiment (use of MPD timeline)

5. Fifth embodiment (distribution system)

6. Sixth embodiment (computer)

### 1. First Embodiment

<Layering of Still Images and Moving Image>

An image encoding/decoding method includes a hierarchical encoding/decoding method for efficiently encoding a multi-layered image, using for example a prediction between layers. Such a layered image includes, for example, a layered image having still images defined as a base layer and a moving image defined as an enhancement layer. That is, in the hierarchical encoding, prediction with reference to the still images is performed to encode the moving image.

As described above, when encoded data thus obtained by hierarchical encoding is hierarchically decoded, the moving image needs to be decoded with reference to the still images. Accordingly, data distribution (in particular, streaming), such as the MPEG-DASH, needs to timely decode the still images.

However, the still image has no concept of time, and it is difficult to control decoding time of encoded still image data. In addition, a conventional file format, such as an MP4 file format, used for such data distribution can only perform timing control based on one timeline. That is, the conventional file does not have function of appropriately controlling decoding time of the encoded data obtained by hierarchically encoding the still images having no concept of time and the moving image having the concept of time.

Therefore, in a file format used for such distribution data, the decoding time of the still images is configured to be specified using the decoding time stamp (DTS) as time information specifying decoding time of frames of the moving image. That is, a correspondence relationship between the still images and the frames of the moving image is expressed using DTS, and information of DTS is stored in a file.

That is, the file is generated to store, in different tracks, encoded still image data obtained by encoding the still images, and encoded moving image data obtained by encoding the moving image using prediction with reference to the still images, time information specifying the decoding time of each frame (DTS) is set in a track of the file storing the encoded moving image data, and time information specifying decoding time of the still images is set in a track of the file storing the encoded still image data, on the basis of a reference relationship between the still images and the moving image for the prediction, using the time information of the encoded moving image data.

With such a configuration, the decoding time of the moving image and the still images can be controlled using one timeline. That is, the decoding time of encoded data obtained by hierarchically encoding a multi-layered image can be controlled.

<Use Case>

The present technology will be described below, on the basis of an example of hierarchical encoding of two-layer image data including the base layer for the still images and the enhancement layer for the moving image, using inter-layer prediction.

Note that, as a matter of course, the image data has an arbitrary number of layers, and may have at least three layers. For example, the still image may have a plurality of layers, or the moving image may have a plurality of layers. Furthermore, each of the images has an arbitrary resolution. The still image may have a resolution higher than that of the moving image or a resolution lower than that of the moving image, or the images may have the same resolution. Similarly, each image may have other parameters, such as a bit depth and a color gamut, having arbitrary values.

First, exemplary usage of such a hierarchical encoding will be described. For example, some of electronic devices including image sensors, such as a digital still camera, a digital video camera, a cellular phone, a smartphone, a laptop personal computer, or a tablet personal computer have a function of capturing a still image in addition to a moving image. For example, some of the electronic devices have a function of capturing a still image by a user's pressing a shutter button, at an arbitrary time during capturing a moving image. Furthermore, for example, some of the electronic devices have a function of saving a moving image in addition to a still image. The moving image is captured before and after capturing the still image, when the user presses a shutter button to capture the still image.

The electronic devices can provide various services for the user, using the moving image and the still images thus saved. For example, an electronic device can provide data of the moving image and data of the still images for the user. Furthermore, for example, an electronic device can use the still images to perform image processing on the moving image for quality improvement, or can use the moving image to make a still image captured at time different from that of a still image having been captured (i.e., change image capture time in a pseudo manner).

In such configurations, the moving image and the still images are substantially similar to each other, and have high similarity between them. That is, moving image data and still image data have high redundancy. Accordingly, the electronic device is configured to perform hierarchical encoding using prediction (inter-layer prediction) referring to the still images to encode the moving image, defining the still image as the base layer and the moving image as the enhancement layer. With such a configuration, efficiency of encoding the moving image data can be increased, the amount of data stored can be reduced, and cost can be reduced.

Furthermore, for example, an electronic device recording a broadcast program have a function of extracting images of some of frames of the moving image periodically or at random, as the still images (thumbnail images), during recording the moving image, and recording the extracted images with the moving image. The still images thus stored are used for example as a graphical user interface (GUI), in a function such as scene search.

In such a configuration, the moving image and the still images are substantially similar to each other, and have high similarity between them. That is, moving image data and still image data have high redundancy. Therefore, the electronic device is configured to perform hierarchical encoding using prediction (inter-layer prediction) referring to the still images to encode the moving image, defining the still image as the base layer and the moving image as the enhancement layer. With such a configuration, efficiency of encoding the moving image data can be increased, the amount of data stored can be reduced, and cost can be reduced.

As a matter of course, the hierarchical encoding is arbitrarily used, and the use of the hierarchical encoding is not limited to these cases.

Furthermore, in the hierarchical encoding, an arbitrary encoding method is used for the still images or the moving image. In the following description, the still images are encoded using joint photographic experts group (JPEG), and the moving image is encoded using the scalable high efficiency video coding (SHVC) format, but, as a matter of course, any other encoding method may be employed.

The present technology is a technology which is applied to transmission of the encoded data thus obtained by hierarchical encoding, in a predetermined transmission format. The present technology will be described below, on the basis of an example of storing the encoded data thus obtained by hierarchical encoding in a file having the MP4 file format.

<MP4 File Format>

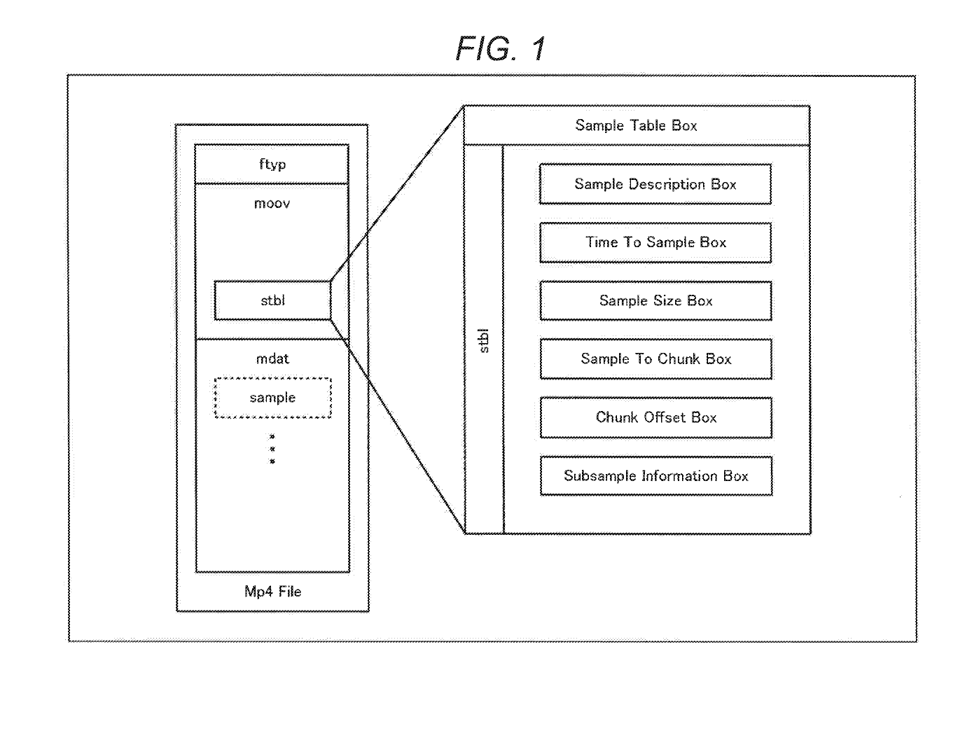

Next, summary of the MP4 file format will be described. As illustrated in FIG. 1, an MP4 file (MP4 file) according to MPEG-DASH includes ftyp, moov, and mdat.

As illustrated in FIG. 1, each sample (picture) data of HEVC is stored, as AV data, in mdat.

Furthermore, in the moov, management information for each sample (e.g., picture) is stored in a sample table box (Sample Table Box (stbl)).

As illustrated in FIG. 1, the sample table box (Sample Table Box) includes a sample description box (Sample Description Box), a time to sample box (Time To Sample Box), a sample size box (Sample Size Box), a sample to chunk box (Sample to Chunk Box), a chunk offset box (Chunk Offset Box), and a subsample information box (Subsample Information Box).

In the sample description box, information about codec, image size, or the like is stored. For example, information about an encoding parameter or the like is stored in an HEVC sample entry (HEVC sample entry) in this sample description box.

In the sample size box, information about sample size is stored. In the sample to chunk box, information about sample data position is stored. In the chunk offset box, information about data offset is stored. In the subsample information box, information about a subsample is stored.

Furthermore, in the time to sample box, sample time information is stored. That is, in this time to sample box, for example, the above-mentioned DTS is set.

<MP4 File Storing Encoded Data Obtained by Such Hierarchical Encoding>

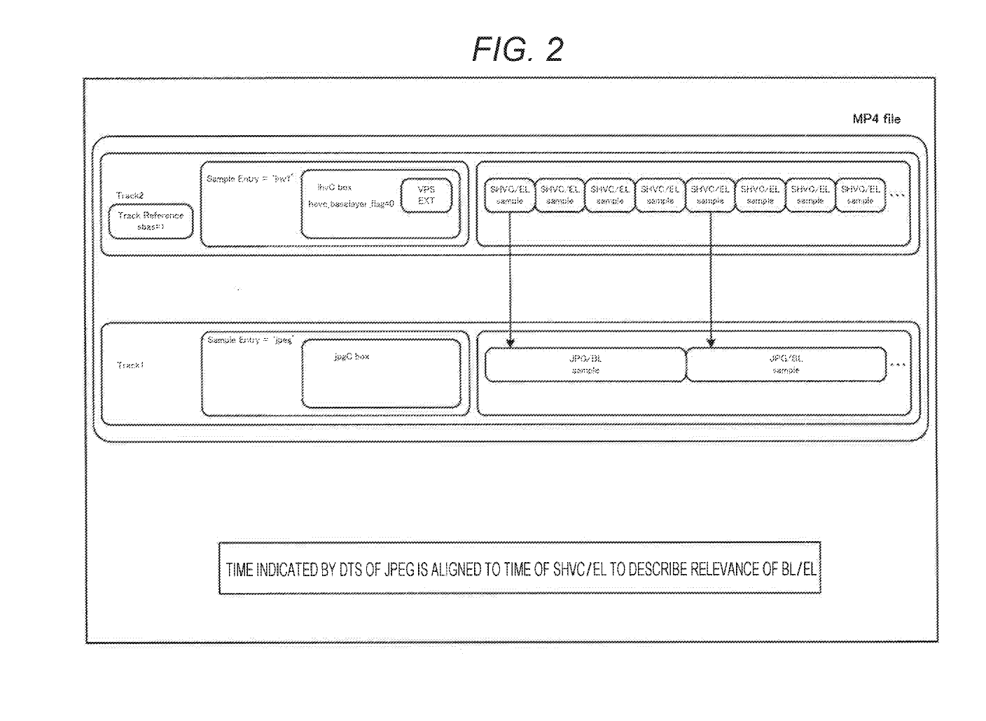

FIG. 2 illustrates an exemplary main configuration of the MP4 file storing the encoded data obtained by hierarchically encoding the still image and the moving image as described above.

In the MP4 file (MP4 file) according to MPEG-DASH illustrated in FIG. 2, the encoded data is divided into layers and each layer is stored in a track. In an example of FIG. 2, track 1 (Track1) stores encoded data (JPG/BL sample) for each sample of the base layer (i.e., still image), and track 2 (Track2) stores encoded data (SHVC/EL sample) for each sample of the enhancement layer (i.e., moving image). The sample of the base layer or the enhancement layer represents a predetermined unit, such as a picture, of the encoded data of each layer (moving image or still image).

In a sample entry in track 1, identification information is set which represents that the encoding method is JPEG (Sample Entry=‘jpeg’). Furthermore, this sample entry has a jpgC box (jpgC box) storing configuration (configuration) information required for decoding JPEG encoded data.

In a sample entry in track 2, identification information is set which represents that the encoding method is SHVC (Sample Entry=‘lhv1’). Furthermore, this sample entry has an lhvC box (lhvc box) storing configuration (configuration) information required for decoding SHVC encoded data. In this lhvC box, flag information (hevc_baselayer_flag) is stored which represents whether the encoding method for the base layer is high efficiency video coding (HEVC). In the example of FIG. 2, since the still images of the base layer are encoded using JPEG, “hevc_baselayer_flag=0” is set in the lhvC box.

Furthermore, this lhvC box stores information of an extension video parameter set (VPS EXT) for the SHVC encoded data. Furthermore, in track 2, track reference (Track Reference) for specifying a track as a reference destination is set. In the example of FIG. 2, track 1 is a base layer, and referred to by track 2, so that “sbas=1” is set in track 2, as track reference (Track Reference).

Furthermore, in the time to sample box (Time To Sample Box) of the sample table box (Sample Table Box) of track 2, DTS of each SHVC sample (SHVC/EL Sample) is set.

In addition, in the time to sample box (Time To Sample Box) of the sample table box (Sample Table Box) of track 1, the DTS of each JPEG sample (JPEG/BL Sample) is set. The DTS of each JPEG sample (JPEG/BL Sample) and the DTS of an SHVC sample of track 1 are set on the same timeline. That is, as indicated by arrows in FIG. 2, an identical value is set to the DTS of each JPEG sample (JPEG/BL Sample), and the DTS of an SHVC sample (SHVC/EL Sample) (e.g., SHVC sample subjected to inter-layer prediction using the JPEG sample) referring to the DTS of the each JPEG sample.

In other words, use of the DTS to align a JPEG timeline and an SHVC timeline with each other, as described above, represents the reference relationship between the base layer and the enhancement layer (i.e., which sample of the enhancement layer refers to which sample of the base layer).

Accordingly, upon decoding the encoded data, the encoded still image data can be timely decoded on the basis of the time information (DTS). Furthermore, upon decoding the encoded moving image data, it can be properly understood that which sample refers to which sample of the base layer, on the basis of the time information (DTS). That is, the moving image can be properly decoded.

<MP4 File Generation Device>

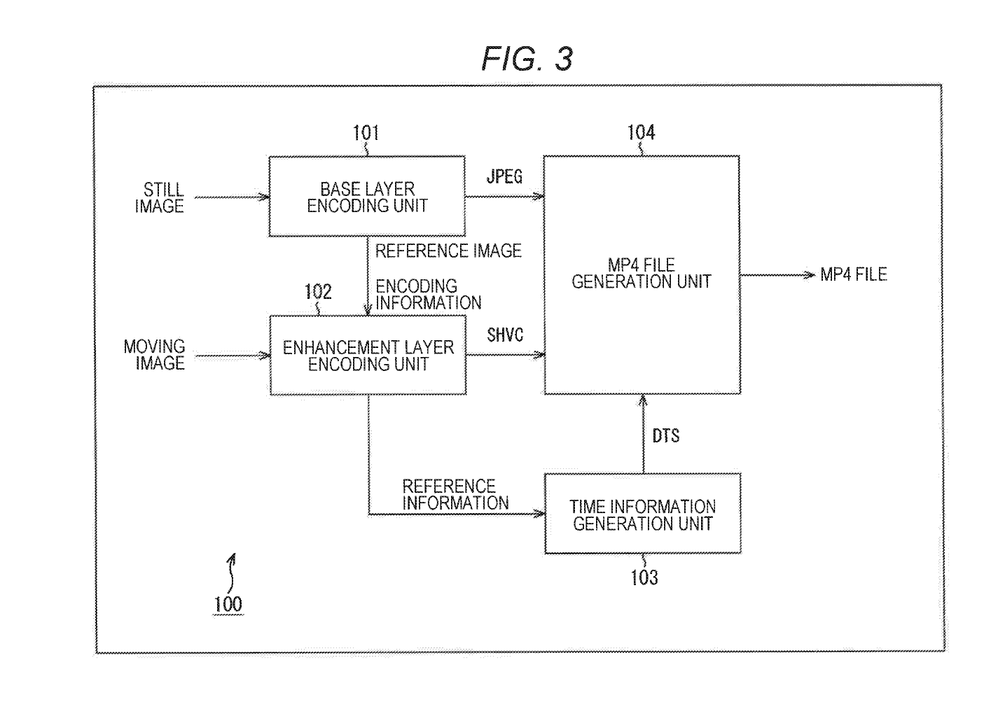

Next, a device for generating such an MP4 file will be described. FIG. 3 is a block diagram illustrating an exemplary main configuration of an MP4 file generation device as one embodiment of an information processing device, and the present technology is applied to the MP4 file generation device. In FIG. 3, the MP4 file generation device 100 hierarchically encodes the still images and the moving image, defining the still images as the base layer, and the moving image to the enhancement layer, and stores the obtained encoded data of each layer in the MP4 file.

As illustrated in FIG. 3, the MP4 file generation device 100 includes a base layer encoding unit 101, an enhancement layer encoding unit 102, a time information generation unit 103, and an MP4 file generation unit 104.

<Flow of MP4 File Generation Process>

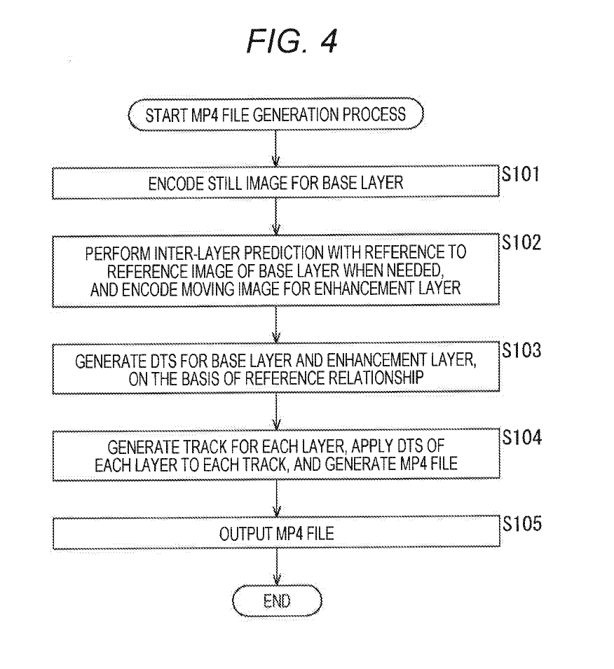

The MP4 file generation device 100 of FIG. 3 performs an MP4 file generation process, to hierarchically encode a still image and a moving image to be input, and generate the MP4 file. An example of a flow of this MP4 file generation process will be described with reference to a flowchart of FIG. 4.

When the still image and the moving image are input, the MP4 file generation device 100 starts the MP4 file generation process. Note that, the still image and moving image to be input are desirably images having a relatively high correlation between them (images having a high similarity in pattern) (higher relativity increases encoding efficiency).

When the MP4 file generation process is started, the base layer encoding unit 101 encodes the input still image for the base layer, in step S101. The base layer encoding unit 101 encodes the still image for example using JPEG, and generates the encoded data (JPEG). The base layer encoding unit 101 supplies the generated encoded base layer data (JPEG) to the MP4 file generation unit 104.

Furthermore, the base layer encoding unit 101 supplies the still image, as a reference image, to the enhancement layer encoding unit 102. The still image may be a decoded image obtained by decoding the encoded data (JPEG). Furthermore, the base layer encoding unit 101 supplies encoding information as information about encoding of the still image to the enhancement layer encoding unit 102.

In step S102, the enhancement layer encoding unit 102 encodes the input moving image for the enhancement layer. The enhancement layer encoding unit 102 encodes the moving image for example using SHVC, and generates the encoded data (SHVC). At that time, the enhancement layer encoding unit 102 uses the reference image of the base layer supplied from the base layer encoding unit 101, when needed, to perform inter-layer prediction. Furthermore, the enhancement layer encoding unit 102 appropriately stores the encoding information of the base layer supplied from the base layer encoding unit 101, or information generated on the basis of the encoding information, in the generated encoded enhancement layer data (SHVC).

Inter-layer prediction can be performed in an arbitrary frame, and does not need to be performed in all frames. SHVC uses both of inter-layer prediction based on reference to the base layer, and inter-frame prediction (temporal prediction) based on reference to another frame of the enhancement layer. The enhancement layer encoding unit 102 supplies the generated encoded enhancement layer data (SHVC) to the MP4 file generation unit 104.

Furthermore, the enhancement layer encoding unit 102 supplies reference information as information about reference in inter-layer prediction, to the time information generation unit 103. The reference information includes, for example, information representing a reference source and a reference destination for an image.

In step S103, the time information generation unit 103 generates time information, that is, the DTS for the base layer and the enhancement layer, on the basis of the supplied reference information. The time information generation unit 103 generates the DTS for each frame of the moving image of the enhancement layer, and generates the DTS for each still image of the base layer, using the DTS of the enhancement layer, on the basis of a reference relationship between the base layer and the enhancement layer represented by the reference information. That is, the time information generation unit 103 sets the DTS of each still image of the base layer to a value the same (same time) as that of the DTS of a frame of the moving image of the enhancement layer, the frame of the moving image referring to the still image. The time information generation unit 103 supplies the generated DTS to the MP4 file generation unit 104.

In step S104, the MP4 file generation unit 104 generates a track for each layer, and applies the DTS of each layer to each track to generate the MP4 file. That is, the MP4 file generation unit 104 generates the MP4 file storing the encoded base layer data (JPEG) supplied from the base layer encoding unit 101 (generated in step S101), and the encoded enhancement layer data (SHVC) supplied from the enhancement layer encoding unit 102 (generated in step S102), in different tracks.

Then, the MP4 file generation unit 104 stores the DTS of the base layer supplied from the time information generation unit 103 (generated in step S103), in a time to sample box in a track storing the encoded base layer data (JPEG) (track 1 in the example of FIG. 2). Furthermore, the MP4 file generation unit 104 stores the DTS of the enhancement layer supplied from the time information generation unit 103 (generated in step S103), in a time to sample box in a track storing the encoded enhancement layer data (SHVC) (track 2 in the example of FIG. 2).

Note that, as described in the above with reference to FIG. 2, the MP4 file generation unit 104 sets identification information “jpeg” in a sample entry in a track of the base layer (track 1). Furthermore, the MP4 file generation unit 104 sets identification information “lhv1”, in a sample entry in a track of the enhancement layer (track 2). Further, the MP4 file generation unit 104 sets a value of “hevc_baselayer_flag” in the lhvC box to “0”. Still further, the MP4 file generation unit 104 sets “sbas=1” as track reference (Track Reference), in a track (track 2) of the enhancement layer. As a matter of course, the MP4 file generation unit 104 also appropriately sets other necessary information.

In step S105, the MP4 file generation unit 104 outputs the MP4 file generated in step S104.

The MP4 file generation process is performed as described above, so that the MP4 file generation device 100 can specify the decoding time of the base layer (still image), using the DTS of the enhancement layer (each frame of the moving image). That is, the decoding time of the encoded data of each layer is indicated to a decoding side, using one timeline. Furthermore, when the base layer has a still image without time information, decoding time can be indicated. In other words, such time information (DTS) can be used to indicate the reference relationship between the base layer and the enhancement layer, to the decoding side.

That is, the MP4 file generation device 100 can control the decoding time of the encoded data obtained by hierarchically encoding a multi-layered image.

<MP4 File Reproduction Device>

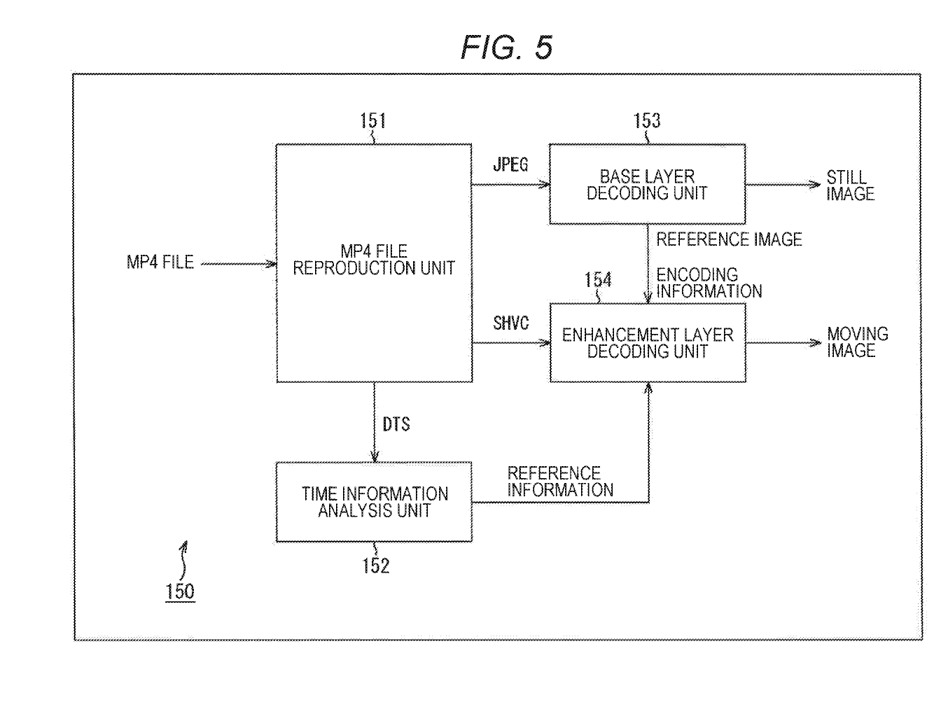

Next, a device for reproducing the MP4 file thus generated will be described. FIG. 5 is a block diagram illustrating an exemplary main configuration of an MP4 file reproduction device as one embodiment of the information processing device, and the present technology is applied to the MP4 file reproduction device. In FIG. 5, the MP4 file reproduction device 150 is a device for reproducing the MP4 file generated as described above by the MP4 file generation device 100 of FIG. 3, generating a decoded image from one or both of the base layer and the enhancement layer, and outputting the decoded image.

As illustrated in FIG. 5, the MP4 file reproduction device 150 has an MP4 file reproduction unit 151, a time information analysis unit 152, a base layer decoding unit 153, and an enhancement layer decoding unit 154.

<Flow of MP4 File Reproduction Process>

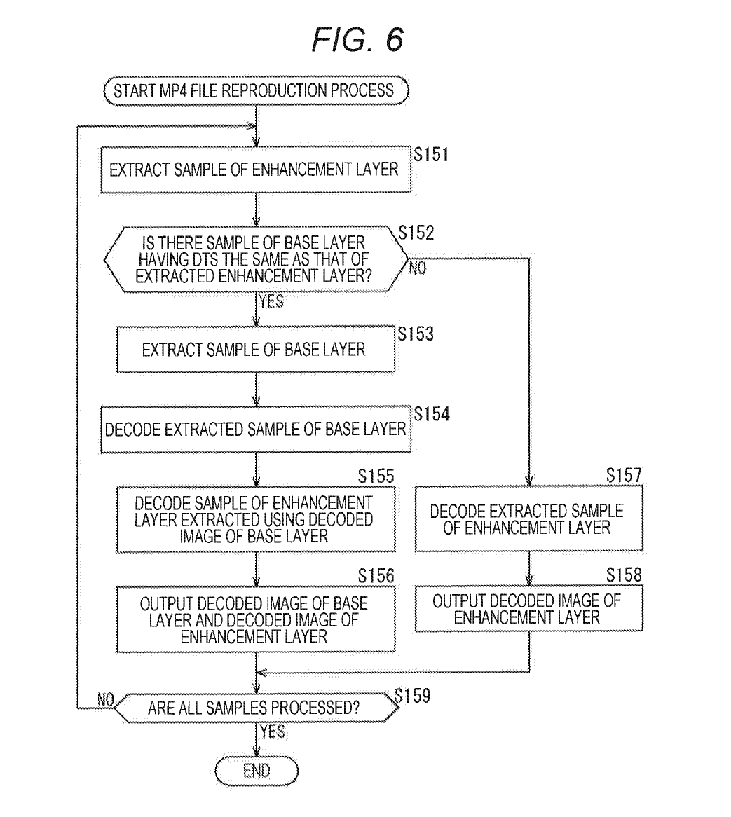

The MP4 file reproduction device 150 of FIG. 5 performs an MP4 file reproduction process to reproduce an MP4 file to be input, and generate a decoded image of an arbitrary layer. An example of a flow of this MP4 file reproduction process will be described with reference to a flowchart of FIG. 6. Note that, in FIG. 6, a process for obtaining the decoded image of the enhancement layer will be described.

When such an MP4 file as illustrated in the example of FIG. 2, storing encoded still image data (JPEG) as the base layer, and encoded moving image data (SHVC) as the enhancement layer is input, the MP4 file reproduction device 150 starts the MP4 file reproduction process.

When the MP4 file reproduction process is started, the MP4 file reproduction unit 151 extracts a current sample of the enhancement layer from the MP4 file (track 2 in the example of FIG. 2), in step S151. The MP4 file reproduction unit 151 supplies the extracted sample of the enhancement layer (SHVC) to the enhancement layer decoding unit 154. Furthermore, the MP4 file reproduction unit 151 extracts time information (DTS) of each track (each layer for hierarchical encoding) from the MP4 file, and supplies the time information to the time information analysis unit 152.

In step S152, on the basis of the DTS supplied from the MP4 file reproduction unit 151, the time information analysis unit 152 determines whether there is a sample of the base layer having a DTS value the same (same time) as that of the sample of the enhancement layer extracted in step S151. When it is determined that there is such a sample of the base layer, the process proceeds to step S153. Note that, the time information analysis unit 152 analyzes, on the basis of the DTS of each layer, a reference relationship between the base layer and the enhancement layer in inter-layer prediction (e.g., which sample of the enhancement layer refers to which sample of the base layer), and supplies reference information representing the reference relationship to the enhancement layer decoding unit 154.

In step S153, the MP4 file reproduction unit 151 extracts the sample of the base layer (i.e., the sample of the base layer determined to have the same DTS, the same time, as that of the sample of the enhancement layer extracted in step S151, in step S152) from the MP4 file (track 1 in the example of FIG. 2). The MP4 file reproduction unit 151 supplies the extracted sample (JPEG) of the base layer to the base layer decoding unit 153.

In step S154, the base layer decoding unit 153 decodes the sample of the base layer supplied from the MP4 file reproduction unit 151 (extracted in step S153), at time designated by the DTS of the sample, using a decoding method (e.g., JPEG format) corresponding to the encoding method of the sample, and generates a decoded image. The base layer decoding unit 153 supplies the decoded image thus generated to the enhancement layer decoding unit 154, as the reference image.

In step S155, on the basis of the reference information supplied from the time information analysis unit 152, the enhancement layer decoding unit 154 uses the reference image supplied from the base layer decoding unit 153 (generated in step S154), that is, the decoded image of the base layer, to perform motion compensation between the layers, decodes the sample of the enhancement layer supplied from the MP4 file reproduction unit 151 (extracted in step S151), and generates a decoded image of the enhancement layer.

In step S156, the base layer decoding unit 153 outputs the decoded image of the base layer generated in step S154. Furthermore, the enhancement layer decoding unit 154 outputs the decoded image of the enhancement layer generated in step S155. After the process of step S156, the process proceeds to step S159.

Furthermore, in step S152, when it is determined that there is no sample of the base layer having a DTS value the same (same time) as that of the sample of the enhancement layer extracted in step S151, the process proceeds to step S157.

In step S157, the enhancement layer decoding unit 154 decodes the sample of the enhancement layer supplied from the MP4 file reproduction unit 151 (extracted in step S151), and generates a decoded image of the enhancement layer.

In step S158, the enhancement layer decoding unit 154 outputs the decoded image of the enhancement layer generated in step S157. After the process of step S158, the process proceeds to step S159.

In step S159, the MP4 file reproduction unit 151 determines whether all samples are processed. When there is a sample not processed, the process returns to step S151, and the processes subsequent to step S151 are repeated. For each sample, the processes of step S151 to step S159 are repeated, and when it is determined that all samples are processed, in step S159, the MP4 file reproduction process ends.

Note that, when only decoding the base layer, the MP4 file reproduction device 150 preferably performs the processes of steps S153 and S154 described above.

Since the MP4 file reproduction process is performed as described above, the MP4 file reproduction device 150 can timely decode the base layer (still image). That is, the MP4 file reproduction device 150 can correctly decode the encoded data obtained by hierarchically encoding a multi-layered image. In particular, the still image without any time information, stored in the base layer, can be correctly decoded.

### 2. Second Embodiment

<POC Reference Table>

Instead of the DTS, a POC reference table representing a reference relationship between the base layer and the enhancement layer may be separately stored.

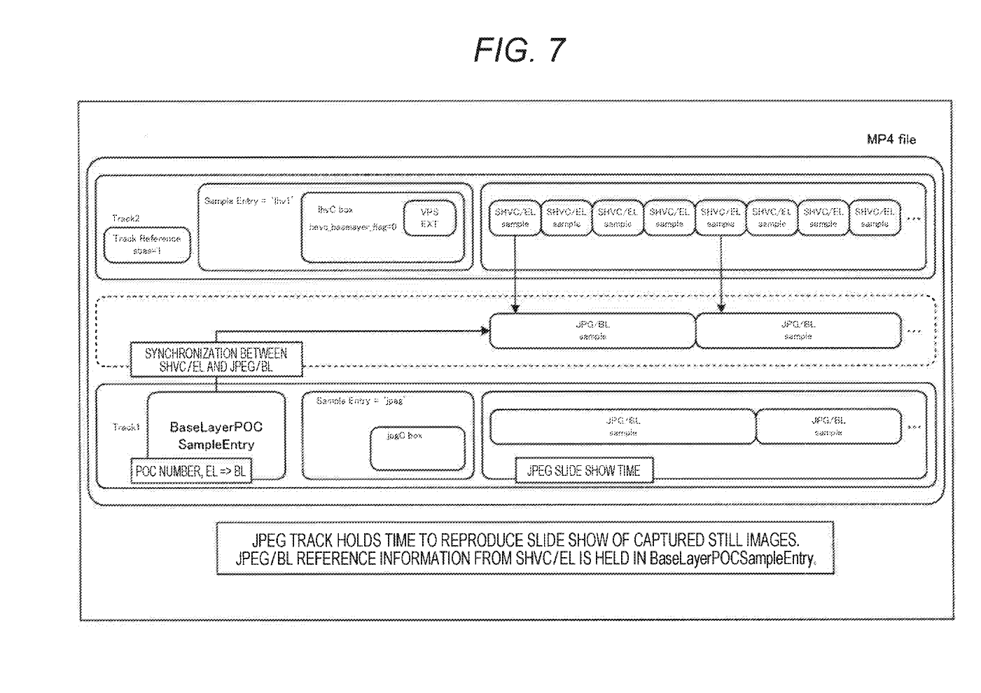

FIG. 7 illustrates an exemplary main configuration of an MP4 file separately storing the POC reference table. In an example of FIG. 7, a first track (Track1) storing the encoded base layer data stores the POC reference table (BaseLayerPOCSampleEntry) representing the reference relationship between the enhancement layer and the base layer using a picture order count (POC). That is, in this (BaseLayerPOCSampleEntry), samples of the enhancement layer (SHVC/EL Sample) as a reference source and samples of the base layer (JPG/BL Sample) as a reference target are indicated using a POC.

Accordingly, with reference to this table, it can be understood that which sample of the enhancement layer refers to which sample of the base layer. That is, it can be understood that which sample of the enhancement layer performs inter-layer prediction. In other words, it can be understood that each sample of the base layer is to be aligned to which sample in the enhancement layer, in decoding time (DTS).

With such a configuration, in the DTS of track 1, decoding time not depending on inter-layer prediction, that is, decoding time only used for decoding the base layer can be stored. For example, when the still images of the base layer are used to reproduce a slide show, the moving image of the enhancement layer is not required, so that only the base layer is preferably decoded. For such a situation, the DTS of track 1 can store decoding time according to reproduction time for the slide show.

That is, each sample in the base layer is decoded timely on the basis of the POC reference table to achieve decoding thereof timely to reproduction of the moving image of the enhancement layer, and each sample of the base layer is decoded timely on the basis of the DTS of track 1 to achieve decoding thereof timely to the slide show. As described above, decoding can be timely performed for multiple usages.

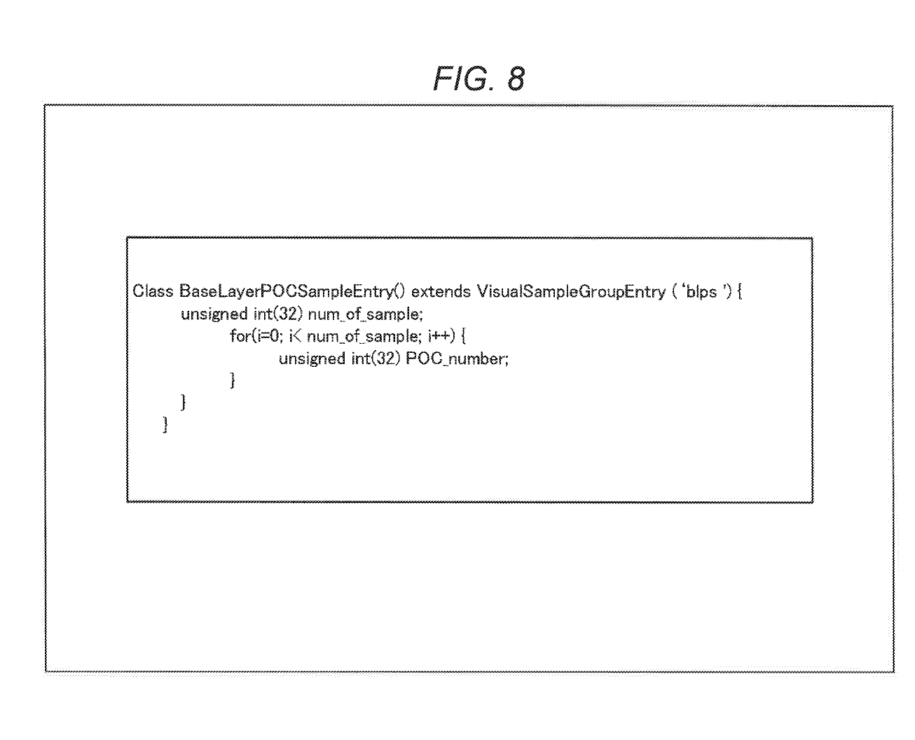

Generation of the POC reference table (BaseLayerPOCSampleEntry) may be performed, for example, according to syntax as illustrated in FIG. 8. In this example, a POC of each sample of the base layer is associated with a POC of the enhancement layer referring to the each sample of the base layer. As a matter of course, the POC reference table has an arbitrary format, and the format is not limited to this example.

<MP4 File Generation Device>

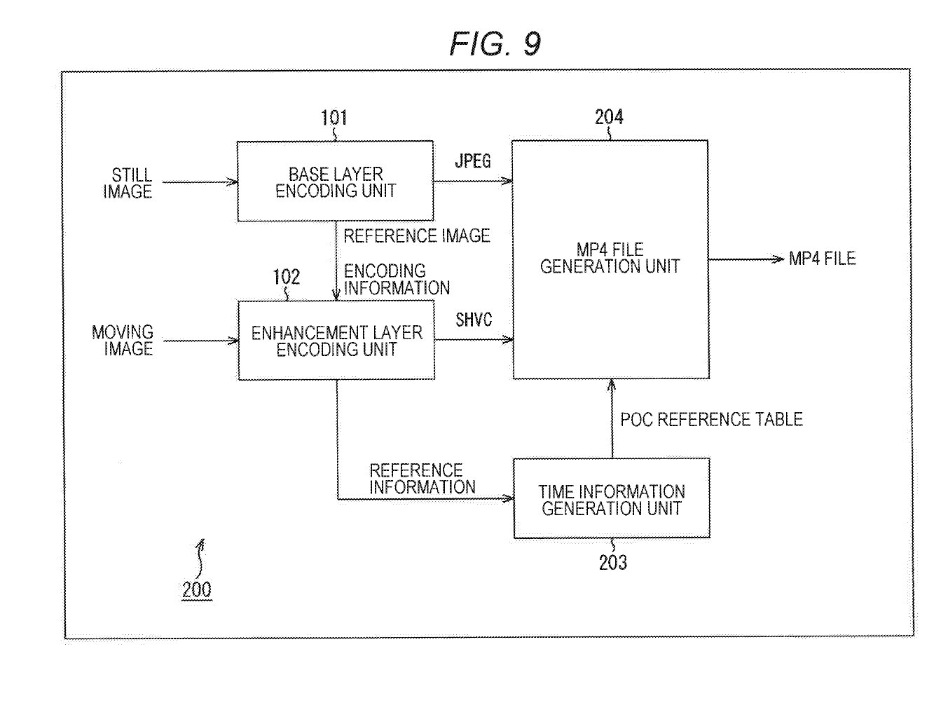

Next, a device for generating such an MP4 file will be described. FIG. 9 is a block diagram illustrating an exemplary main configuration of an MP4 file generation device as one embodiment of the information processing device, and the present technology is applied to the MP4 file generation device. In FIG. 9, the MP4 file generation device 200 is a device similar to the MP4 file generation device 100 (FIG. 3), and basically has a configuration similar to that of the MP4 file generation device 100. However, the MP4 file generation device 200 has a time information generation unit 203, instead of the time information generation unit 103 in the MP4 file generation device 100. Furthermore, the MP4 file generation device 200 has an MP4 file generation unit 204, instead of the MP4 file generation unit 104 in the MP4 file generation device 100.

The time information generation unit 203 generates the POC reference table on the basis of reference information, instead of generating DTS, and supplies the POC reference table to the MP4 file generation unit 204. The MP4 file generation unit 204 stores the POC reference table in the MP4 file, instead of storing the DTS in the MP4 file.

<Flow of MP4 File Generation Process>

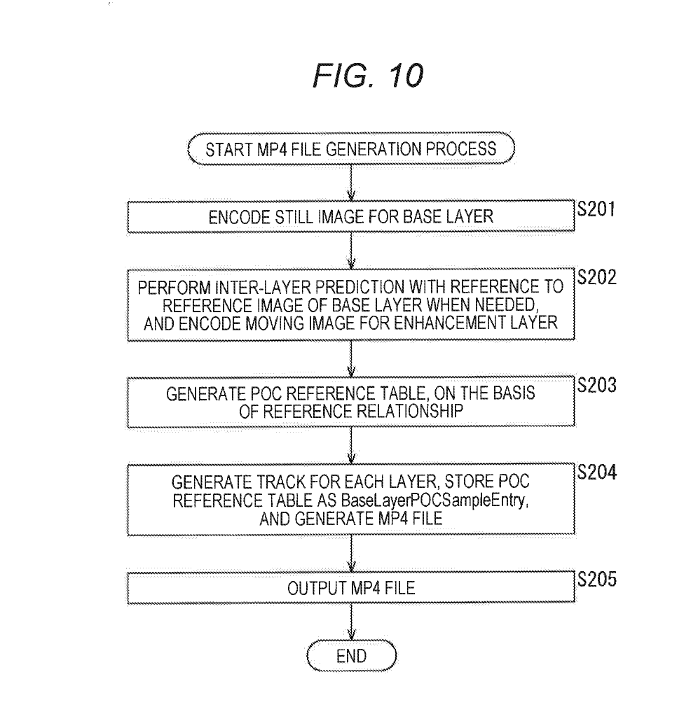

An example of a flow of an MP4 file generation process performed by the MP4 file generation device 100 of FIG. 9 will be described with reference to a flowchart of FIG. 10.

The processes of steps S201 and S202 are performed in a similar manner to the processes of steps S101 and S102 of FIG. 4. Note that, the base layer encoding unit 101 supplies the generated encoded base layer data (JPEG) to the MP4 file generation unit 204. Furthermore, the enhancement layer encoding unit 102 supplies the generated encoded enhancement layer data (SHVC) to the MP4 file generation unit 204, and the reference information as information about reference in inter-layer prediction to the time information generation unit 203.

In step S203, the time information generation unit 203 generates the POC reference table (BaseLayerPOCSampleEntry), on the basis of the supplied reference information. The time information generation unit 203 supplies the generated POC reference table (BaseLayerPOCSampleEntry) to the MP4 file generation unit 204.

In step S204, the MP4 file generation unit 204 generates a track for each layer, and applies the DTS of each layer to each track to generate the MP4 file. That is, the MP4 file generation unit 204 generates the MP4 file storing the encoded base layer data (JPEG) supplied from the base layer encoding unit 101 (generated in step S101), and the encoded enhancement layer data (SHVC) supplied from the enhancement layer encoding unit 102 (generated in step S102), in different tracks.

Then, the MP4 file generation unit 204 stores the POC reference table supplied from the time information generation unit 203 (generated in step S203), in a track (track 1 in the example of FIG. 7) storing the encoded base layer data (JPEG).

Furthermore, the MP4 file generation unit 204 sets DTS for a track (track 2 in the example of FIG. 7) storing the encoded enhancement layer data (SHVC). Furthermore, the MP4 file generation unit 204 appropriately sets the DTS for a track (track 1 in the example of FIG. 7) storing the encoded base layer data (JPEG).

Note that, the MP4 file generation unit 204 appropriately sets other necessary information, as in the first embodiment.

In step S205, the MP4 file generation unit 204 outputs the MP4 file generated in step S204.

The MP4 file generation process is performed as described above, so that the MP4 file generation device 200 can specify the decoding time of the base layer (still image), using the POC reference table. That is, the decoding time of the encoded data of each layer is indicated to the decoding side, using one timeline. Furthermore, when the base layer has a still image without time information, decoding time can be indicated.

That is, the MP4 file generation device 200 can control the decoding time of the encoded data obtained by hierarchically encoding a multi-layered image.

<MP4 File Reproduction Device>

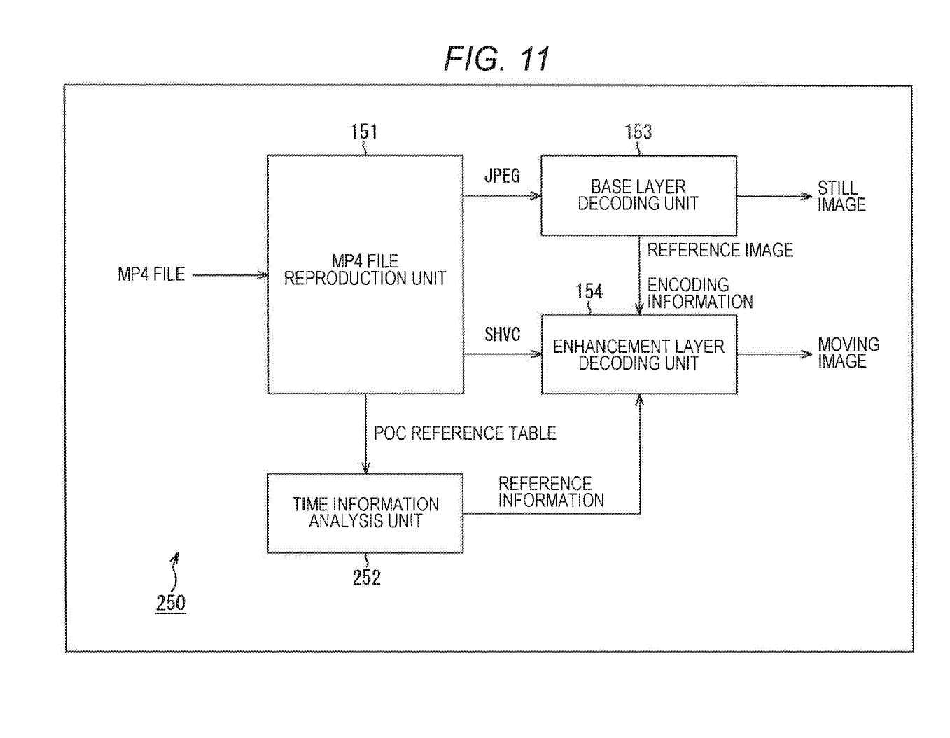

Next, a device for reproducing the MP4 file thus generated will be described. FIG. 11 is a block diagram illustrating an exemplary main configuration of an MP4 file reproduction device as one embodiment of the information processing device, and the present technology is applied to the MP4 file reproduction device. In FIG. 11, the MP4 file reproduction device 250 is a device for reproducing the MP4 file generated as described above by the MP4 file generation device 200 of FIG. 9, generating a decoded image from one or both of the base layer and the enhancement layer, and outputting the decoded image.

As illustrated in FIG. 11, the MP4 file reproduction device 250 basically has a configuration similar to that of the MP4 file reproduction device 150 (FIG. 5). However, the MP4 file reproduction device 250 has a time information analysis unit 252, instead of the time information analysis unit 152 in the MP4 file reproduction device 150.

<Flow of MP4 File Reproduction Process>

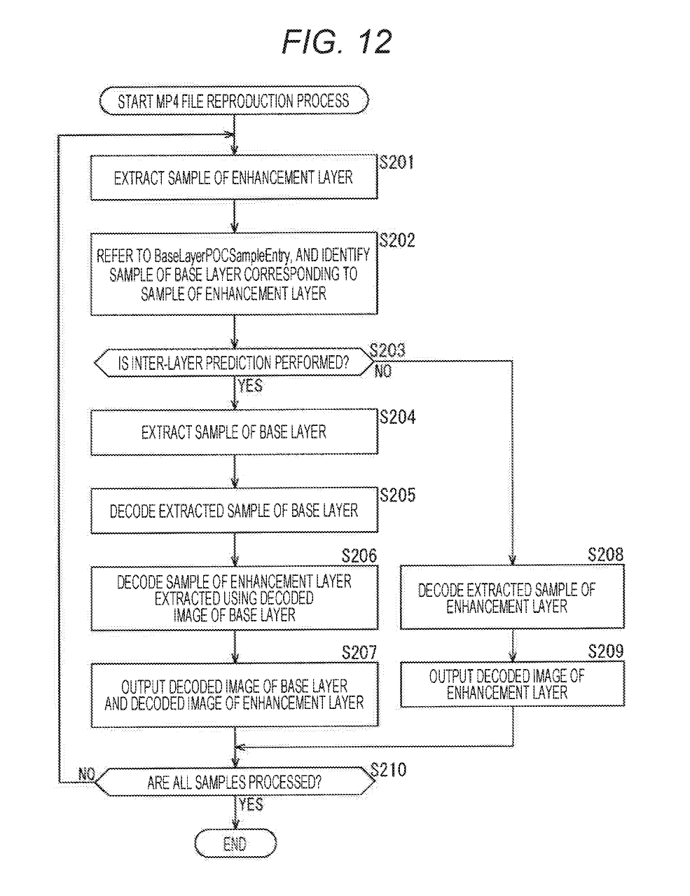

An example of a flow of an MP4 file reproduction process performed by the MP4 file reproduction device 250 of FIG. 11 will be described with reference to a flowchart of FIG. 12. Note that, in FIG. 12, a process for obtaining the decoded image of the enhancement layer will be described.

When the MP4 file reproduction process is started, the MP4 file reproduction unit 151 extracts a current sample of the enhancement layer from the MP4 file (track 2 in the example of FIG. 7), in step S251. The MP4 file reproduction unit 151 supplies the extracted sample of the enhancement layer (SHVC) to the enhancement layer decoding unit 154. Furthermore, the MP4 file reproduction unit 151 extracts the POC reference table (BaseLayerPOCSampleEntry) from the MP4 file (track 1 in the example of FIG. 7), and supplies the POC reference table to the time information analysis unit 252.

In step S252, the time information analysis unit 252 identifies a sample (POC of the sample) of the base layer corresponding to a sample (POC of the sample) of the enhancement layer extracted by the MP4 file reproduction unit 151 (extracted in step S251), on the basis of the POC reference table (BaseLayerPOCSampleEntry) supplied from the MP4 file reproduction unit 151.

In step S253, the time information analysis unit 252 determines whether to perform inter-layer prediction. In step S252, when the sample of the base layer corresponding to the sample of the enhancement layer is identified (exists), the time information analysis unit 252 determines to perform inter-layer prediction. In this case, the process proceeds to step S254.

Note that, the time information analysis unit 252 analyzes a reference relationship between the base layer and the enhancement layer for inter-layer prediction (e.g., which sample of the enhancement layer refers to which sample of the base layer), on the basis of the POC reference table, and supplies the reference information representing the reference relationship to the enhancement layer decoding unit 154.

The processes of steps S254 to S257 are performed in a similar manner to the processes of steps S153 to S156 of FIG. 6. After the process of step S257, the process proceeds to step S260.

Furthermore, when the sample of the base layer corresponding to the sample of the enhancement layer is not identified (not exist), in step S252, the time information analysis unit 252 determines not to preform inter-layer prediction, in step S253. In this case, the process proceeds to step S258.

The processes of steps S258 and S259 are performed in a similar manner to the processes of steps S157 and S158 of FIG. 6. After the process of step S259, the process proceeds to step S260.

In step S260, the MP4 file reproduction unit 151 determines whether all samples are processed. When there is a sample not processed, the process returns to step S251, and the processes subsequent to step S251 are repeated. For each sample, the processes of step S251 to step S260 are repeated, and when it is determined that all samples are processed, in step S260, the MP4 file reproduction process ends.

Note that, when only decoding the base layer, the MP4 file reproduction device 250 preferably performs the processes of steps S254 and S255 described above.

Since the MP4 file reproduction process is performed as described above, the MP4 file reproduction device 250 can timely decode the base layer (still image). That is, the MP4 file reproduction device 250 can correctly decode the encoded data obtained by hierarchically encoding a multi-layered image. In particular, the still image without any time information, stored in the base layer, can be correctly decoded.

### 3. Third Embodiment

<Link of JPEG Data>

An entity of the encoded base layer data (JPEG file) may be positioned outside the MP4 file. In this situation, the MP4 file preferably stores link information indicating a storage location of the entity of the JPEG file.

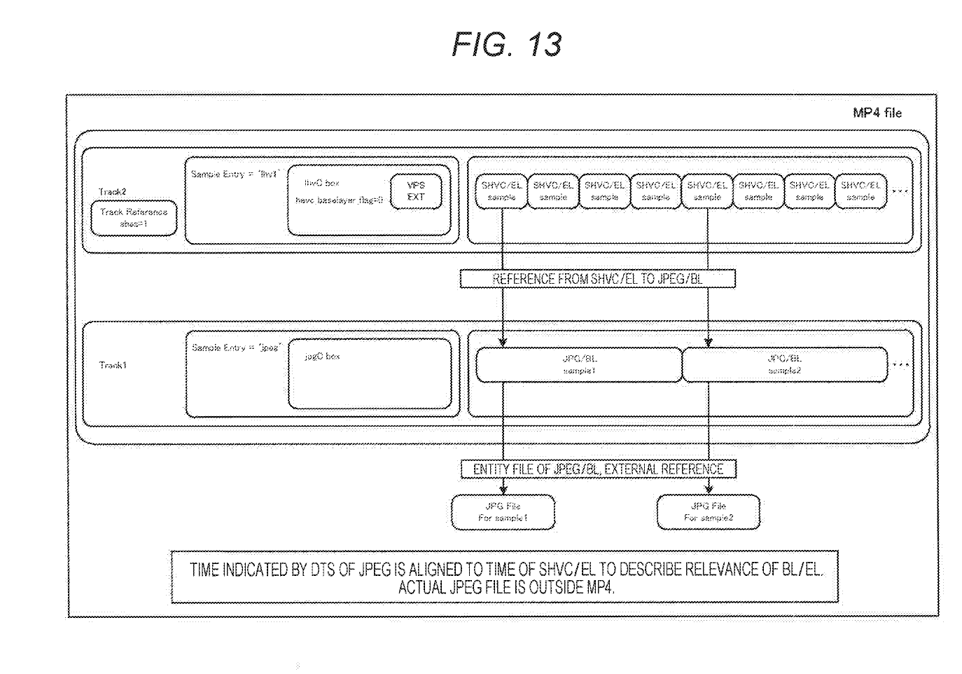

FIG. 13 illustrates an exemplary main configuration of the MP4 file storing the link information. In an example of FIG. 13, the MP4 file basically has a configuration similar to that in the example of FIG. 2, and a reference relationship between the base layer and the enhancement layer is represented by DTS. However, in an example of FIG. 13, a track of the base layer (track 1) stores, link information for an entity of the JPEG file (JPG File For sample1, JPG File For sample2, or the like), as a sample of the encoded data (JPG/BL sample1, JPG/BL sample2, or the like).

When decoding the base layer, the entity of the JPEG file is preferably read on the basis of the link information. A configuration other than the above is similar to that of the first embodiment.

<MP4 File Generation Device>

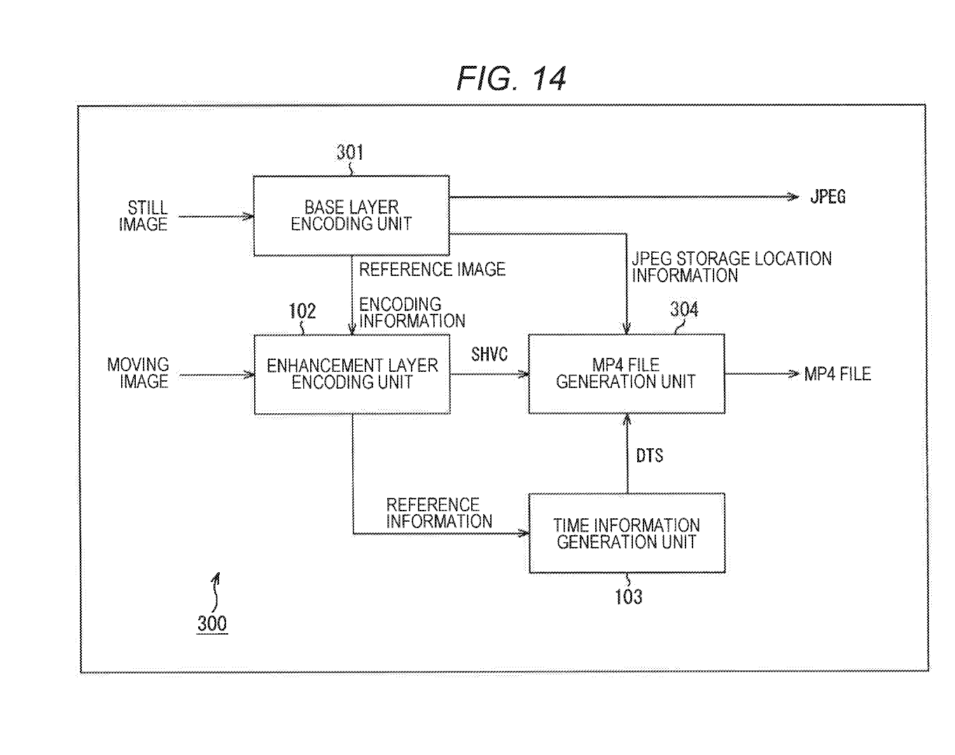

Next, a device for generating such an MP4 file will be described. FIG. 14 is a block diagram illustrating an exemplary main configuration of an MP4 file generation device as one embodiment of the information processing device, and the present technology is applied to the MP4 file generation device. In FIG. 14, the MP4 file generation device 300 is a device similar to the MP4 file generation device 100 (FIG. 3), and basically has a configuration similar to that of the MP4 file generation device 100. However, the MP4 file generation device 300 has a base layer encoding unit 301, instead of the base layer encoding unit 101 in the MP4 file generation device 100. Furthermore, the MP4 file generation device 300 has an MP4 file generation unit 304 instead of the MP4 file generation unit 104 in the MP4 file generation device 100.

The base layer encoding unit 301 outputs an entity of the generated encoded base layer data (JPEG), and transmits notification of a storage location of the encoded data (JPEG) to the MP4 file generation unit 304 (e.g., supplied as JPEG storage location information to the MP4 file generation unit 304). The MP4 file generation unit 304 stores the link information (JPEG storage location information) of the entity of the encoded base layer data (JPEG), instead of storing the entity of the encoded base layer data (JPEG) in the MP4 file (track 1).

<Flow of MP4 File Generation Process>

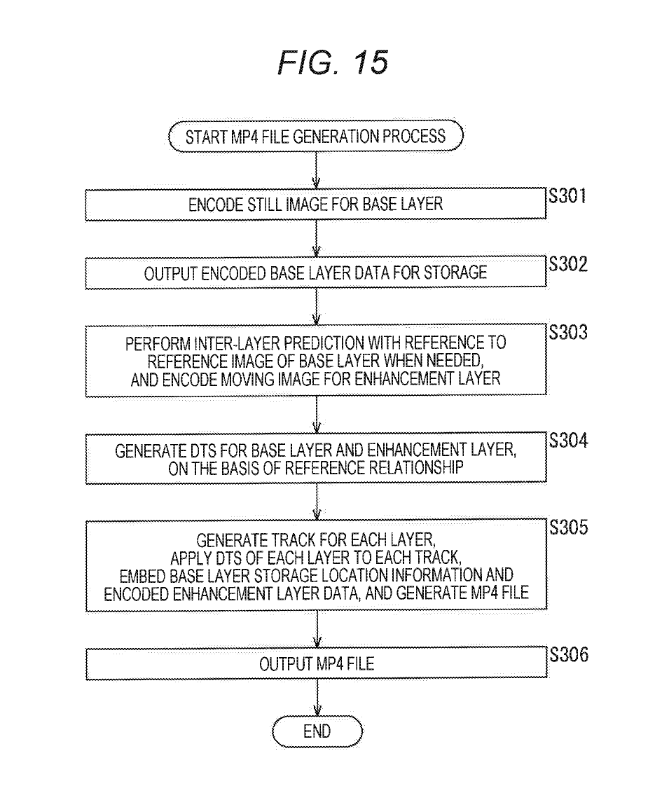

An example of a flow of an MP4 file generation process performed by the MP4 file generation device 100 of FIG. 14 will be described with reference to a flowchart of FIG. 15.

When the MP4 file generation process is started, the base layer encoding unit 301 encodes the input still image for the base layer, in step S301. The base layer encoding unit 301 encodes the still image for example using JPEG, and generates the encoded data (JPEG).

In step S302, the base layer encoding unit 301 outputs the generated encoded base layer data (JPEG), and stores the encoded base layer data in a predetermined storage location. The base layer encoding unit 301 supplies the JPEG storage location information indicating the storage location of the encoded data (JPEG) to the MP4 file generation unit 304. Furthermore, the base layer encoding unit 301 supplies a reference image (still image) and encoding information to the enhancement layer encoding unit 102, in a similar manner to the base layer encoding unit 101.

The processes of steps S303 and S304 are performed in a similar manner to the processes of steps S102 and S103 of FIG. 4. Note that, the enhancement layer encoding unit 102 supplies the generated encoded enhancement layer data (SHVC) to the MP4 file generation unit 304.

In step S305, the MP4 file generation unit 304 generates a track for each layer, and applies the DTS of each layer to each track to generate the MP4 file. That is, the MP4 file generation unit 304 stores the JPEG storage location information supplied from the base layer encoding unit 101, in a track of the base layer (track 1 in the example of FIG. 13), and stores the encoded enhancement layer data (SHVC) supplied from the enhancement layer encoding unit 102 (generated in step S304), in a track of the enhancement layer (track 2 in the example of FIG. 13).

Then, the MP4 file generation unit 304 stores the DTS of the base layer supplied from the time information generation unit 103 (generated in step S304), in a time to sample box of a track storing the encoded base layer data (JPEG) (track 1 in the example of FIG. 13). Furthermore, the MP4 file generation unit 304 stores the DTS of the enhancement layer supplied from the time information generation unit 103 (generated in step S304), in a time to sample box of a track storing the encoded enhancement layer data (SHVC) (track 2 in the example of FIG. 13).

Note that, the MP4 file generation unit 304 appropriately sets other necessary information, as in the first embodiment.

In step S306, the MP4 file generation unit 304 outputs the MP4 file generated in step S305.

The MP4 file generation process is performed as described above, so that the MP4 file generation device 300 can specify the decoding time of the base layer (still image), using the DTS of the enhancement layer (each frame of the moving image). That is, the decoding time of the encoded data of each layer is indicated to a decoding side, using one timeline. Furthermore, when the base layer has a still image without time information, decoding time can be indicated. In other words, such time information (DTS) can be used to indicate the reference relationship between the base layer and the enhancement layer, to the decoding side.

That is, the MP4 file generation device 300 can control the decoding time of the encoded data obtained by hierarchically encoding a multi-layered image, even if the entity of the encoded base layer data (JPEG file) is positioned outside the MP4 file.

<MP4 File Reproduction Device>

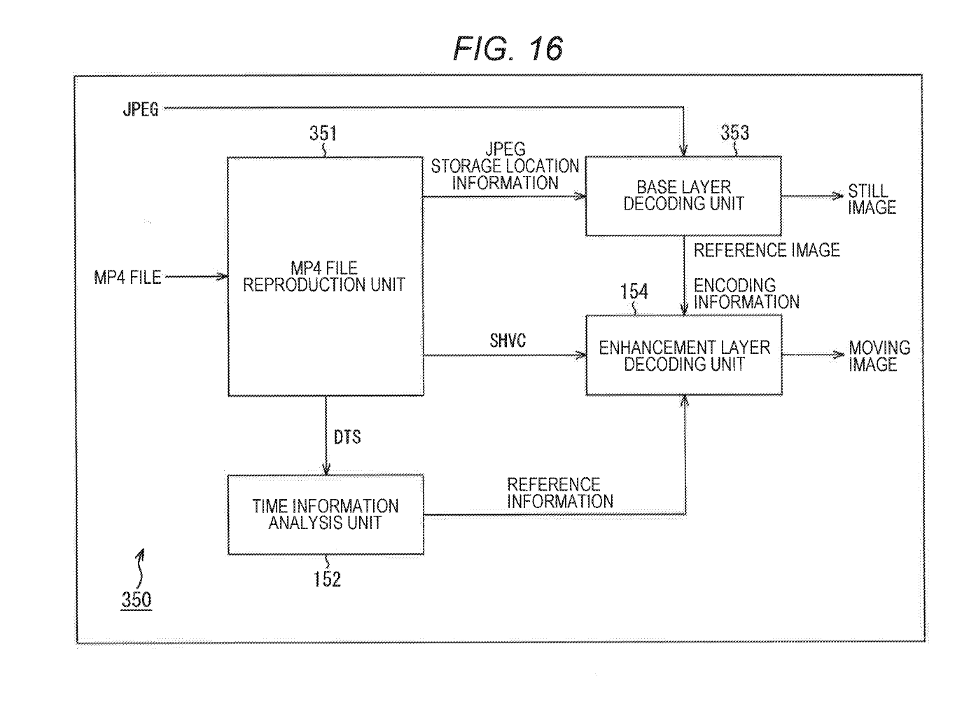

Next, a device for reproducing the MP4 file thus generated will be described. FIG. 16 is a block diagram illustrating an exemplary main configuration of an MP4 file reproduction device as one embodiment of the information processing device, and the present technology is applied to the MP4 file reproduction device. In FIG. 16, the MP4 file reproduction device 350 is a device for reproducing the MP4 file generated as described above by the MP4 file generation device 300 of FIG. 14, generating a decoded image from one or both of the base layer and the enhancement layer, and outputting the decoded image.

As illustrated in FIG. 16, the MP4 file reproduction device 350 basically has a configuration similar to that of the MP4 file reproduction device 150 (FIG. 5). However, the MP4 file reproduction device 350 has an MP4 file reproduction unit 352, instead of the MP4 file reproduction unit 151 in the MP4 file reproduction device 150. Furthermore, the MP4 file reproduction device 350 has a base layer decoding unit 353 instead of the base layer decoding unit 153 in the MP4 file reproduction device 150.

<Flow of MP4 File Reproduction Process>

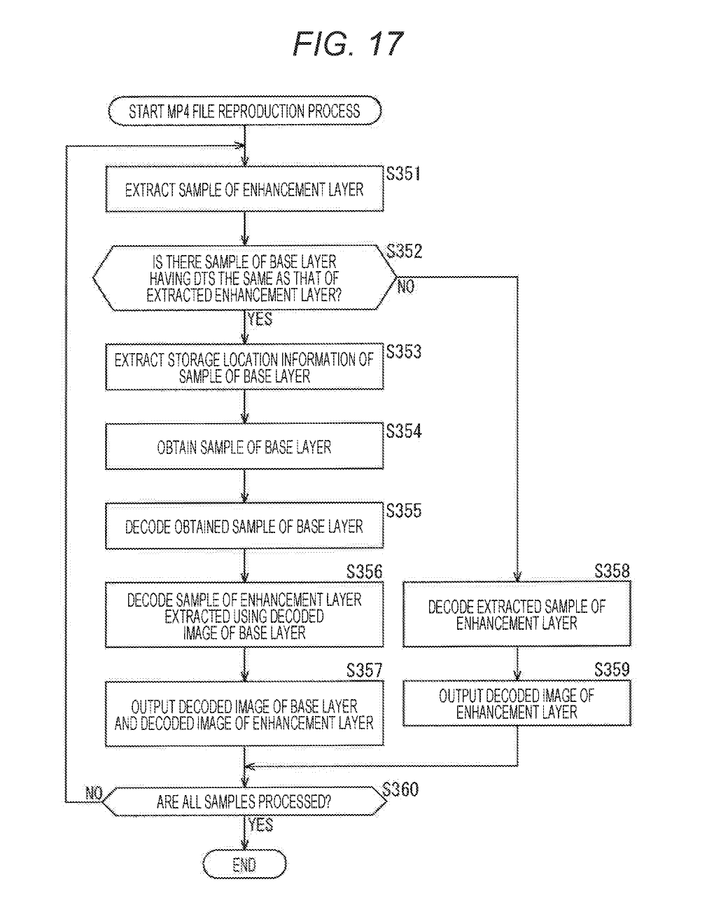

An example of a flow of an MP4 file reproduction process performed by the MP4 file reproduction device 250 of FIG. 16 will be described with reference to a flowchart of FIG. 17. Note that, in FIG. 17, a process for obtaining the decoded image of the enhancement layer will be described.

When the MP4 file reproduction process is started, the MP4 file reproduction unit 351 extracts a current sample of the enhancement layer from the MP4 file (track 2 in the example of FIG. 13), in step S351. The MP4 file reproduction unit 351 supplies the extracted sample of the enhancement layer (SHVC) to the enhancement layer decoding unit 154. Furthermore, the MP4 file reproduction unit 351 extracts time information (DTS) of each track (each layer for hierarchical encoding) from the MP4 file, and supplies the time information to the time information analysis unit 152.

In step S352, on the basis of the DTS supplied from the MP4 file reproduction unit 351, the time information analysis unit 152 determines whether there is a sample of the base layer having a DTS value the same (same time) as that of the sample of the enhancement layer extracted in step S351. When it is determined that there is the sample of the base layer, the process proceeds to step S353. Note that, the time information analysis unit 152 analyzes, on the basis of the DTS of each layer, a reference relationship between the base layer and the enhancement layer in inter-layer prediction (e.g., which sample of the enhancement layer refers to which sample of the base layer), and supplies reference information representing the reference relationship to the enhancement layer decoding unit 154.

In step S353, the MP4 file reproduction unit 351 extracts storage location information (JPEG storage location information) of the sample of the base layer, from the MP4 file (track 1 in the example of FIG. 13). The MP4 file reproduction unit 351 supplies the extracted storage location information (JPEG storage location information) to the base layer decoding unit 353.

In step S354, the base layer decoding unit 353 obtains the entity of the encoded base layer data (JPEG), on the basis of the storage location information (JPEG storage location information) of the sample of the base layer.

The processes of steps S355 to S357 are performed in a similar manner to the processes of steps S154 to S156 of FIG. 6. After the process of step S357, the process proceeds to step S360.

Furthermore, in step S352, when it is determined that there is no sample of the base layer having a DTS value the same (same time) as that of the sample of the enhancement layer extracted in step S351, the process proceeds to step S358.

The processes of steps S358 and S359 are performed in a similar manner to the processes of steps S157 and S158 of FIG. 6. After the process of step S359, the process proceeds to step S360.

In step S360, the MP4 file reproduction unit 351 determines whether all samples are processed. When there is a sample not processed, the process returns to step S351, and the processes subsequent to step S351 are repeated. For each sample, the processes of step S351 to step S360 are repeated, and when it is determined that all samples are processed, in step S360, the MP4 file reproduction process ends.

Note that, when only decoding the base layer, the MP4 file reproduction device 350 preferably performs the processes of steps S353 and S355 described above.

Since the MP4 file reproduction process is performed as described above, MP4 file reproduction device 350 can timely decode the base layer (still image). That is, the MP4 file reproduction device 350 can correctly decode the encoded data obtained by hierarchically encoding a multi-layered image. In particular, even if the base layer has a still image without any time information, or even if the encoded data of the still image has an entity not stored in the MP4 file, the still image can be correctly decoded.

### 4. Fourth Embodiment

<Control by MPD>

The Control of decoding time of the encoded base layer data (JPEG file) may be performed in media presentation description (MPD) of moving picture experts group-dynamic adaptive streaming over HTTP (MPEG-DASH).

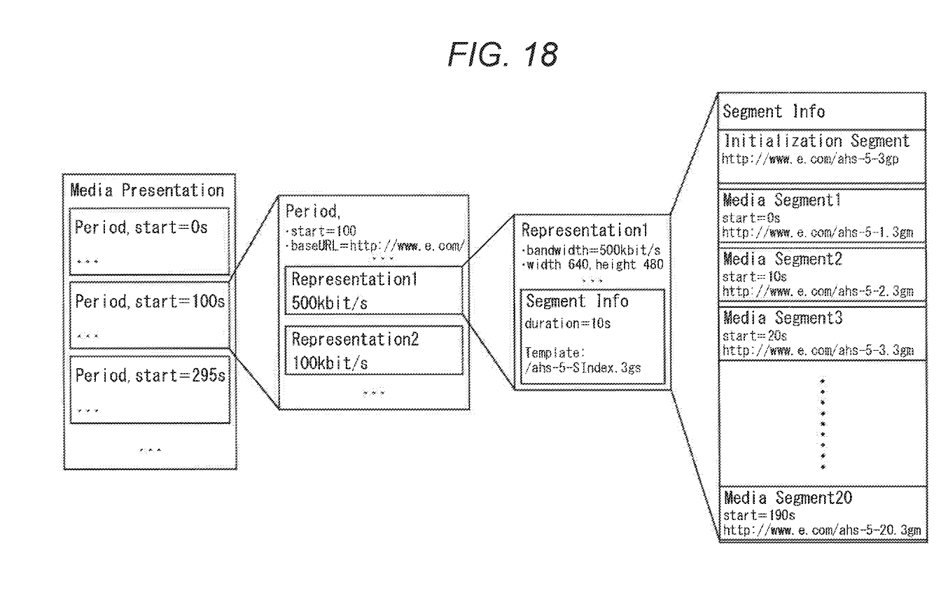

The MPD has for example a configuration as illustrated in FIG. 18. In analysis (parsing) of the MPD, a client selects an optimal attribute from representations (Representation) included in a period (Period) of the MPD (Media Presentation of FIG. 18).

The client reads a first segment (Segment) of the selected representation (Representation) to obtain and process an initialization segment (Initialization Segment). Then, the client obtains and reproduces a subsequent segment (Segment).

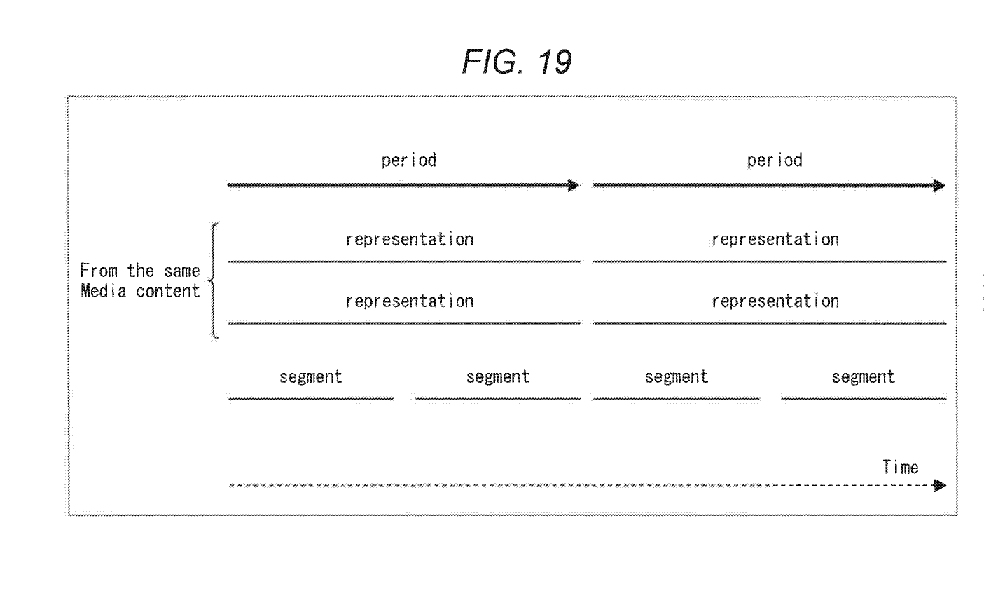

Note that, a relationship between the period (Period), the representation (Representation), and the segment (Segment) in the MPD is represented as illustrated in FIG. 19. That is, one media content can be managed in each period (Period) as temporal data unit, and each period (Period) can be managed in each segment (Segment) as a temporal data unit. Furthermore, each period (Period) can include a plurality of representations (Representation) having different attributes such as bit rates.

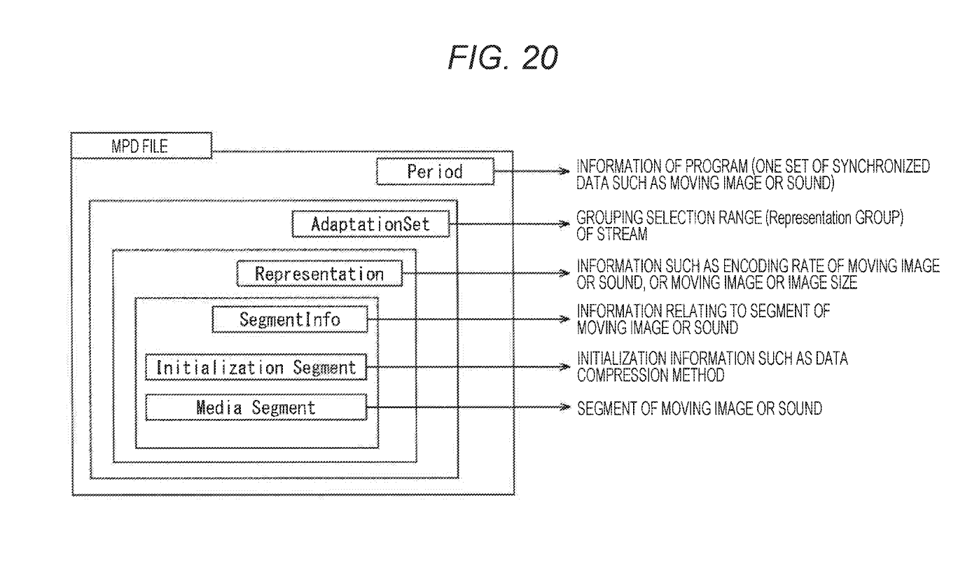

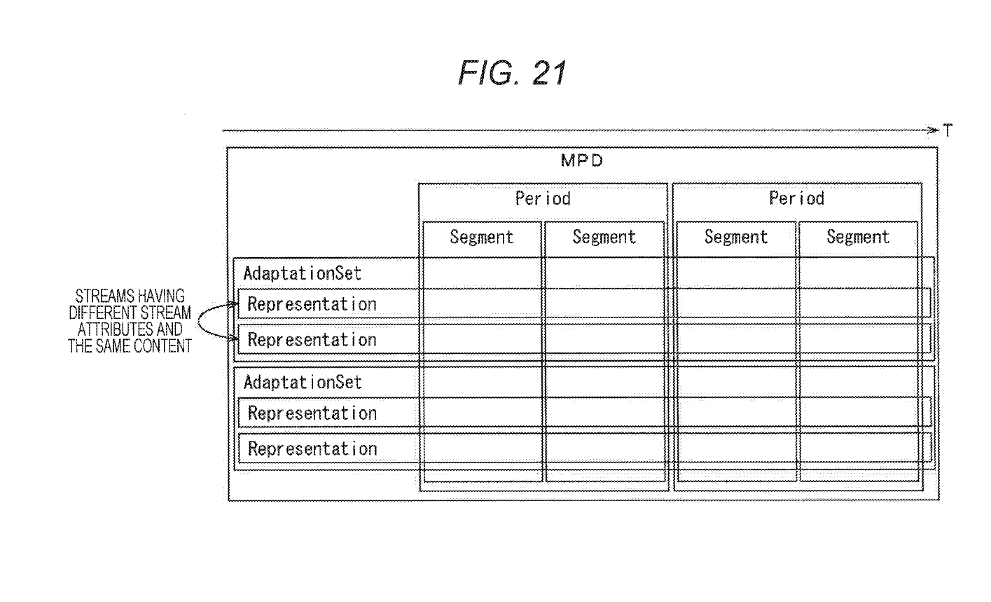

Accordingly, in this file of MPD (also referred to as MPD file), the period (Period) has a lower layer structure as illustrated in FIG. 20. Furthermore, this structure of the MPD is arranged on a temporal axis, as illustrated in an example of FIG. 21. As apparent from the example of FIG. 21, an identical segment (Segment) includes a plurality of representations (Representation). The client adaptively can select any of the representations, to obtain appropriate stream data according to a communication environment, decoding capability of the client, or the like, and reproduce the stream data.

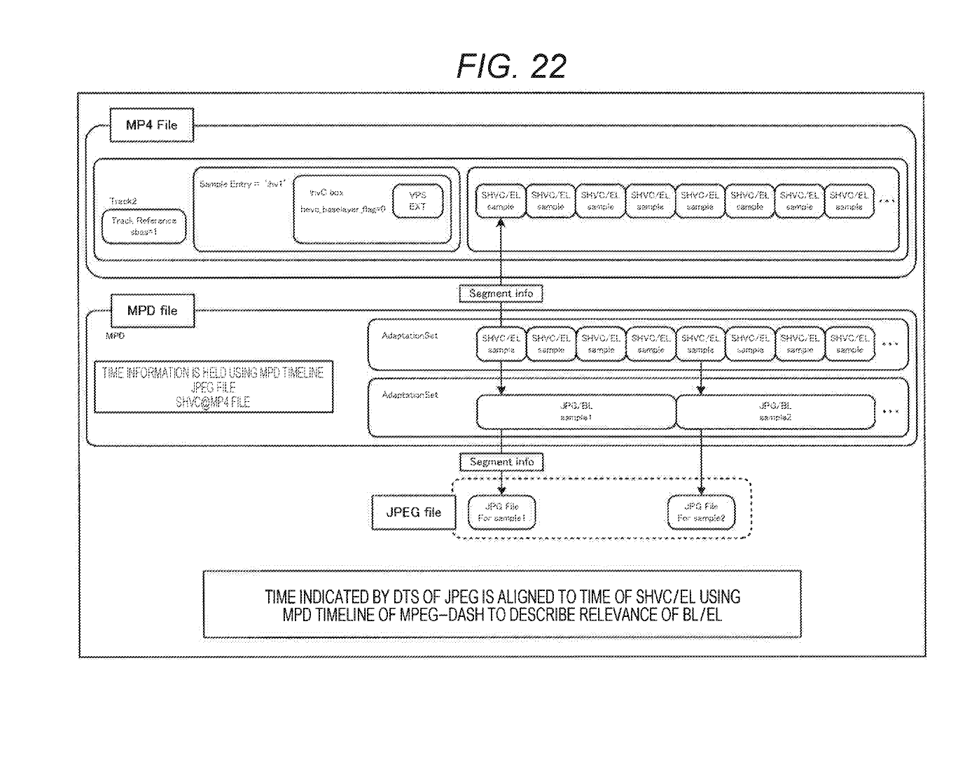

FIG. 22 illustrates an exemplary configuration of each file for controlling decoding time of the encoded base layer data (JPEG file), using such an MPD. In an example of FIG. 22, the encoded base layer data is configured as a JPEG file (JPG File) (JPG File For sample1, JPG File For sample2), and the encoded enhancement layer data is configured as an MP4 file (MP4 File), and these files are managed by an MPD file (MPD File).

In this configuration, MP4 file preferably has a track 2, as a track, for storing the encoded enhancement layer data. The track 2 has a configuration as described in other embodiments.

In the MPD file, AdaptationSet is set for each layer, and a link to an entity of encoded data is set by SegmentInfo. Time information of each sample of the encoded base layer data (JPG/BL sample1, JPG/BL sample2), and each sample of the encoded enhancement layer data (SHVC/EL sample) is managed using an MPD timeline. That is, decoding time of each layer is aligned using the MPD time line.

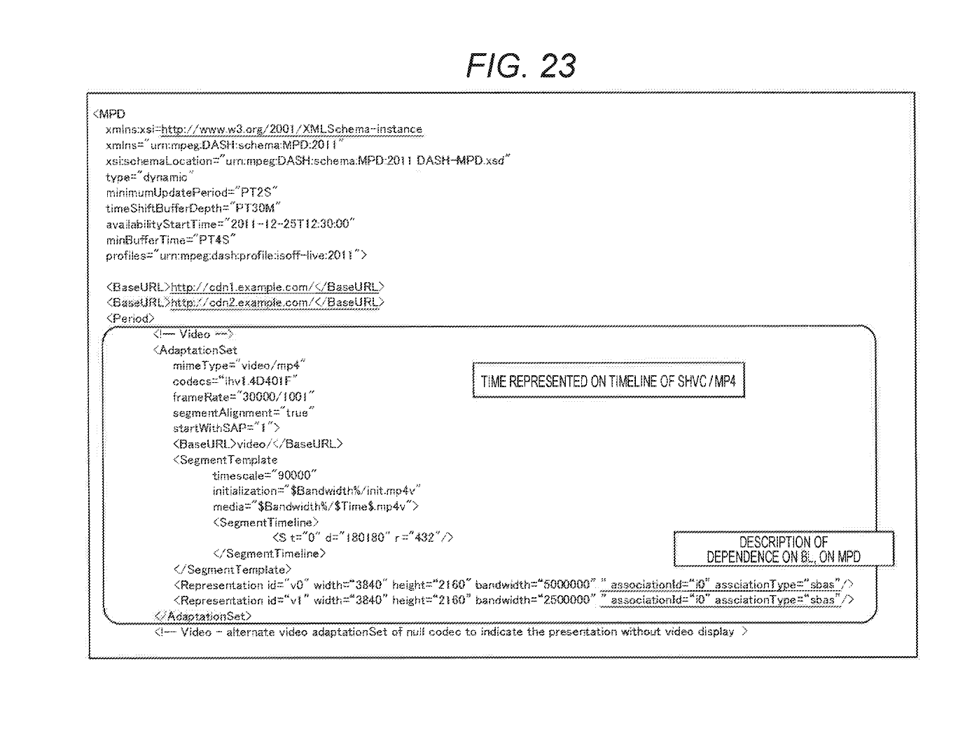

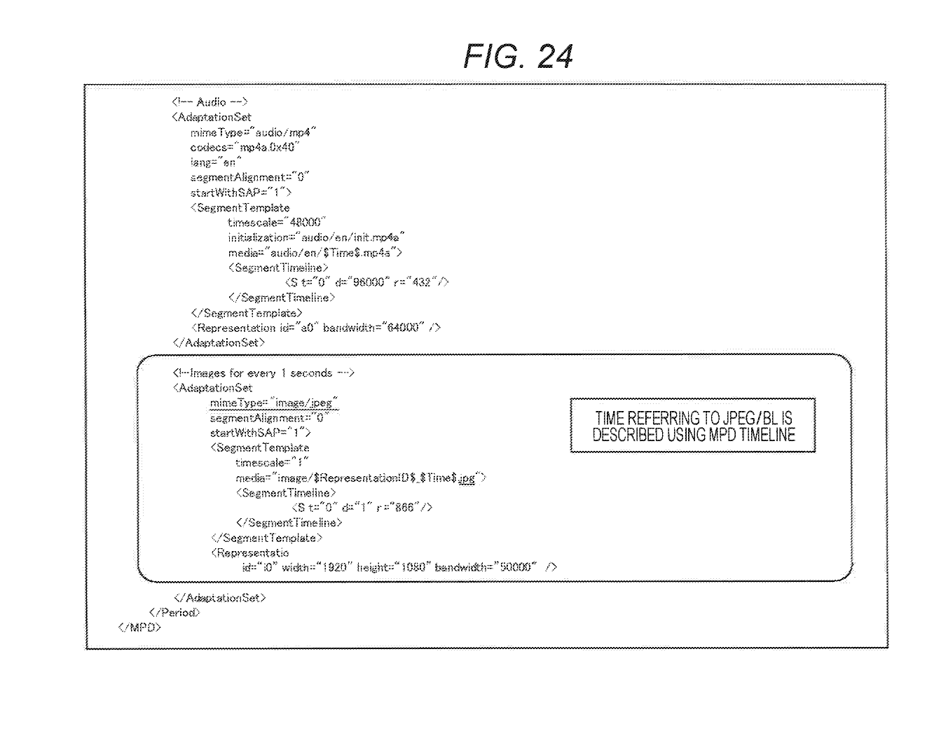

An example of description of such an MPD is illustrated in FIGS. 23 and 24. In FIG. 23, setting of AdaptationSet of the enhancement layer is described in a rounded square, and decoding time of the encoded data (SHVC) is represented using the MPD timeline. In FIG. 24, setting of AdaptationSet of the base layer is described in a rounded square, and decoding time of the encoded data (JPEG) is represented using the MPD timeline.

As described above, the MPD timeline can be used to control the decoding time of the encoded data obtained by hierarchically encoding a multi-layered image.

<File Generation Device>

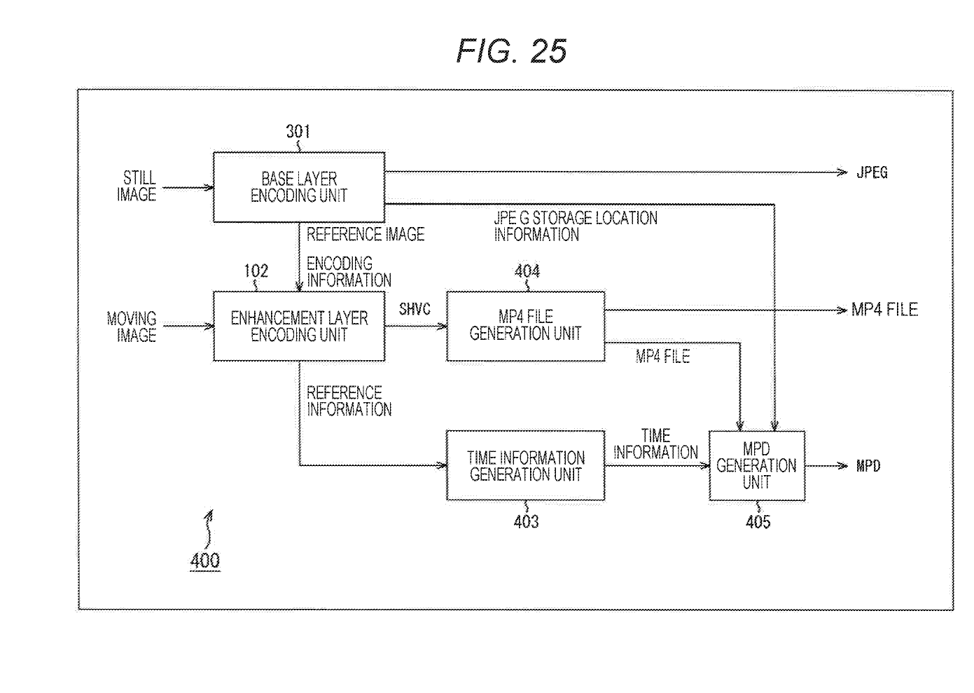

Next, a device for generating such an MPD or an MP4 file will be described. FIG. 25 is a block diagram illustrating an exemplary main configuration of a file generation device as one embodiment of the information processing device, and the present technology is applied to the file generation device. In FIG. 25, the file generation device 400 hierarchically encodes the still images and the moving image, defining the still images as the base layer, and the moving image as the enhancement layer, and generates and outputs a JPEG file, an MP4 file, an MPD, and the like.

The file generation device 400 basically has a configuration similar to that of the MP4 file generation device 300 (FIG. 14). However, the file generation device 400 has a time information generation unit 403, instead of the time information generation unit 103 in the MP4 file generation device 300. Further, the file generation device 400 has an MP4 file generation unit 404 instead of the MP4 file generation unit 304 in the MP4 file generation device 300. Still further, the file generation device 400 has an MPD generation unit 405.

The base layer encoding unit 301 is configured as described in the third embodiment, but supplies the JPEG storage location information not to the MP4 file generation unit 304 but to the MPD generation unit 405. Furthermore, the enhancement layer encoding unit 102 supplies the encoded data (SHVC) to the MP4 file generation unit 404, and the reference information to the time information generation unit 403. The time information generation unit 403 generates time information (DTS) on the basis of the reference information, and supplies the time information to the MPD generation unit 405. The MP4 file generation unit 404 generates an MP4 file storing the encoded enhancement layer data (SHVC), and outputs the MP4 file. Furthermore, the MP4 file generation unit 404 supplies the generated MP4 file to the MPD generation unit 405.

The MPD generation unit 405 generates an MPD for controlling reproduction of the MP4 file of the enhancement layer and the JPEG file of the base layer. Then, the MPD generation unit 405 converts the time information (DTS) of each layer to the MPD timeline to be described in the MPD. The MPD generation unit 405 outputs the generated MPD.

<Flow of File Generation Process>

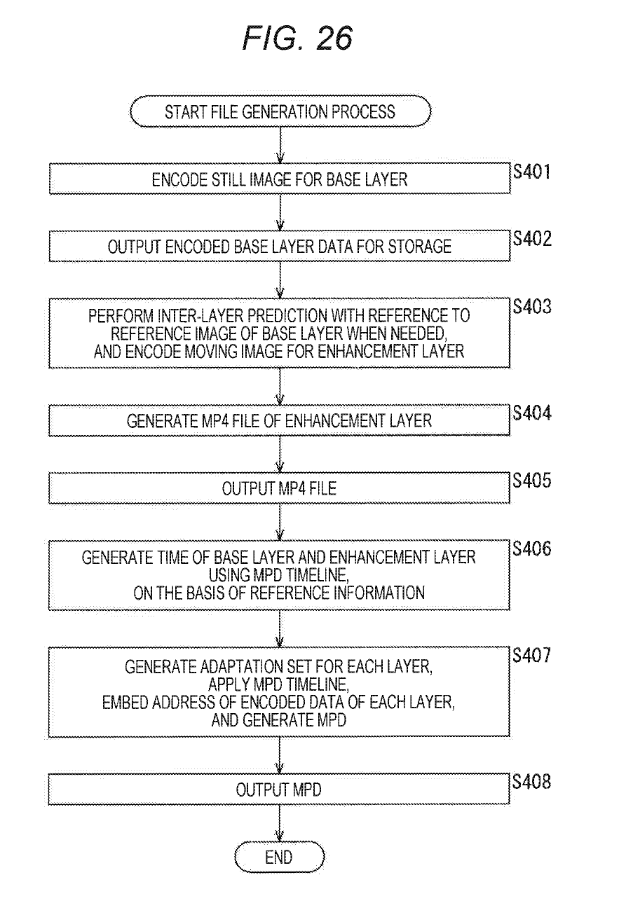

An example of a flow of a file generation process performed by the file generation device 400 of FIG. 25 will be described with reference to a flowchart of FIG. 26.

The processes of steps S401 to S403 are performed in a similar manner to the processes of steps S301 to S303 of FIG. 15. Note that, the base layer encoding unit 301 outputs the generated encoded base layer data (JPEG), and stores the encoded base layer data in a predetermined storage location. Further, the base layer encoding unit 301 supplies the JPEG storage location information indicating the storage location of the encoded data (JPEG) to the MPD generation unit 405. Still further, the base layer encoding unit 301 supplies a reference image (still image) and encoding information to the enhancement layer encoding unit 102.

Furthermore, the enhancement layer encoding unit 102 supplies the generated encoded enhancement layer data (SHVC) to the MP4 file generation unit 404, and the reference information as information about reference in inter-layer prediction to the time information generation unit 403.

In step S404, the MP4 file generation unit 404 generates an MP4 file storing the supplied encoded enhancement layer data (SHVC).

In step S405, the MP4 file generation unit 404 outputs the generated MP4 file. Furthermore, the MP4 file generation unit 404 supplies the generated MP4 file to the MPD generation unit 405.

In step S406, the time information generation unit 403 represents time (decoding time) of respective samples of the base layer and the enhancement layer on the MPD timeline, on the basis of the reference information supplied from the enhancement layer encoding unit 102 (i.e., reference relationship between respective samples of the base layer and the enhancement layer). The time information generation unit 403 supplies, as the time information, time of respective samples of the base layer and the enhancement layer indicated on the MPD timeline, to the MPD generation unit 405.

In step S407, the MPD generation unit 405 generates an MPD for controlling the base layer and the enhancement layer. That is, the MPD generation unit 405 generates AdaptationSet for each layer. Then, the MPD generation unit 405 describes link information (link information of each sample) indicating a storage location of the JPEG file as the encoded base layer data, in SegmentInfo of AdaptationSet of the base layer. Furthermore, the MPD generation unit 405 describes link information indicating a storage location of the MP4 file including the encoded enhancement layer data, in SegmentInfo of AdaptationSet of the enhancement layer.

Furthermore, the MPD generation unit 405 stores the time information generated in step S406, in the MPD. That is, the MPD generation unit 405 describes the decoding time of each sample of each layer represented on the MPD timeline, in the MPD.

In step S408, the MPD generation unit 405 outputs the MPD generated as described above. After output of the MPD, the file generation process ends.

The file generation process is performed as described above, so that the file generation device 400 can control the decoding time of each sample of each layer, on the MPD timeline. That is, the decoding time of the encoded data of each layer is indicated to a decoding side, using one timeline. Furthermore, when the base layer has a still image without time information, decoding time can be indicated. In other words, such time information can be used to indicate the reference relationship between the base layer and the enhancement layer, to the decoding side.

That is, file generation device 400 can control the decoding time of the encoded data obtained by hierarchically encoding a multi-layered image.

<File Reproduction Device>

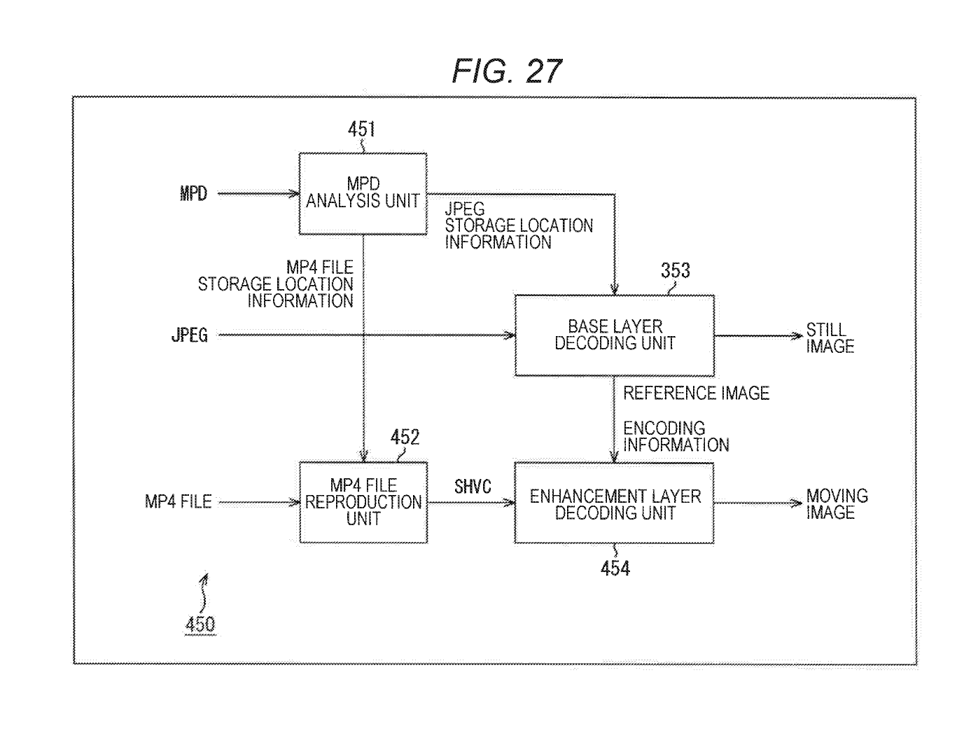

Next, a device for reproducing the MPD, the MP4 file, the JPEG file, or the like thus generated will be described. FIG. 27 is a block diagram illustrating an exemplary main configuration of a file reproduction device, as one embodiment of the information processing device, and the present technology is applied to the file reproduction device. In FIG. 27, the file reproduction device 450 is a device for reproducing the MPD, MP4 file, and JPEG file generated as described above by the file generation device 400 of FIG. 25, generating a decoded image from one or both of the base layer and the enhancement layer, and outputting the decoded image.

As illustrated in FIG. 27, the file reproduction device 450 basically has a configuration similar to that of the MP4 file reproduction device 350 (FIG. 16). However, the file reproduction device 450 has an MPD analysis unit 451. Furthermore, the file reproduction device 450 has an MP4 file reproduction unit 452 instead of the MP4 file reproduction unit 351 in the MP4 file reproduction device 350. Furthermore, the file reproduction device 450 has an enhancement layer decoding unit 454 instead of the enhancement layer decoding unit 154 in the MP4 file reproduction device 350. Note that, the file reproduction device 450 does not have a time information analysis unit 152 which is included in the MP4 file reproduction device 350.

The MPD analysis unit 451 analyzes MPD to be input, and controls reproduction of the MP4 file or reproduction of the JPEG file. The MPD analysis unit 451 supplies the JPEG storage location information indicating the storage location of the JPEG file, to the base layer decoding unit 353, and supplies MP4 file storage location information indicating a storage location of the MP4 file, to the MP4 file reproduction unit 452, in order to perform decoding at the decoding time specified on the MPD timeline.

According to the control of the MPD analysis unit 451, the MP4 file reproduction unit 452 obtains the MP4 file from a place specified by the MP4 file storage location information, reproduces the MP4 file, and extracts a sample of the encoded enhancement layer data (SHVC). The MP4 file reproduction unit 452 supplies the extracted MP4 file to the enhancement layer decoding unit 454.

Furthermore, the base layer decoding unit 353 is configured as described in the third embodiment, but supplies a reference image and encoding information not to the enhancement layer decoding unit 154 but to the enhancement layer decoding unit 454.

The enhancement layer decoding unit 454 uses the reference image or the encoding information, when needed, to decode the encoded enhancement layer data (SHVC), and generate the decoded image of the moving image. The enhancement layer decoding unit 454 outputs the moving image (decoded image).

<Flow of File Reproduction Process>

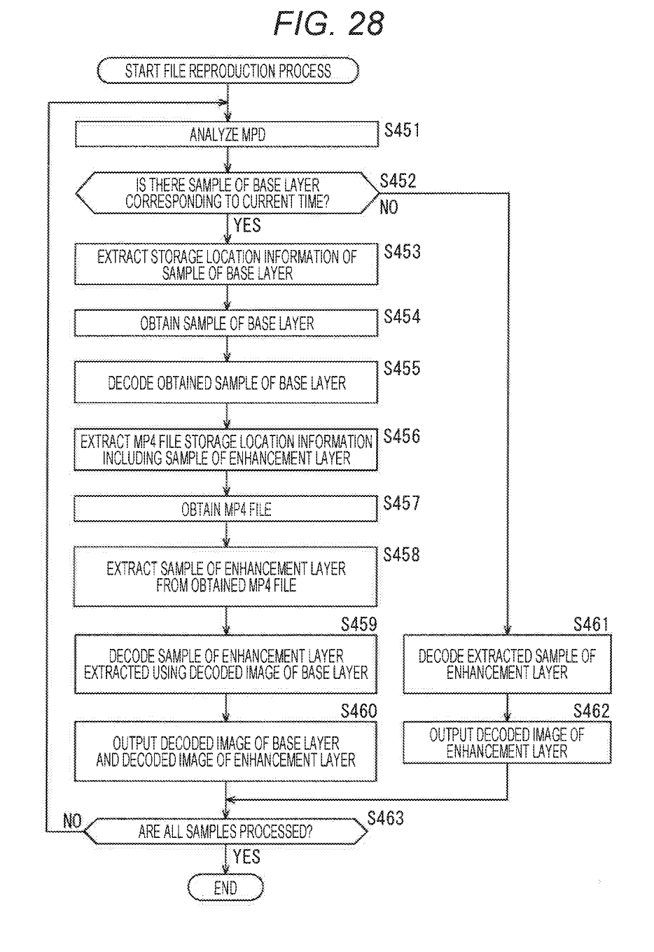

An example of a flow of a file reproduction process performed by the file reproduction device 450 of FIG. 27 will be described with reference to a flowchart of FIG. 28. Note that, in FIG. 28, a process for obtaining the decoded image of the enhancement layer will be described.

When the file reproduction process is started, the MPD analysis unit 451 analyzes the input MPD, in step S451.

In step S452, the MPD analysis unit 451 determines whether there is a sample of the base layer corresponding to current time, on the basis of the time information of each layer described in the MPD. That is, the MPD analysis unit 451 determines whether there is a sample having decoding time the same as time (decoding time) of a current sample of the enhancement layer, in the base layer. In other words, the MPD analysis unit 451 determines whether inter-layer prediction is performed on the current sample of the enhancement layer upon encoding. When it is determined that there is the sample of the base layer (inter-layer prediction is performed), process proceeds to step S453.

The processes of steps S453 to S455 are performed in a similar manner to the processes of steps S353 to S355 of FIG. 17.

The base layer decoding unit 353 supplies, as the reference image, the obtained decoded still image to the enhancement layer decoding unit 454. Furthermore, the base layer decoding unit 353 supplies the encoding information to the enhancement layer decoding unit 454.

In step S456, the MPD analysis unit 451 extracts the MP4 file storage location information (link information to the entity of the MP4 file) described in the MPD, and supplies the MP4 file storage location information to the MP4 file reproduction unit 452.

In step S457, the MP4 file reproduction unit 452 obtains the MP4 file, on the basis of the MP4 file storage location information.

In step S458, the MP4 file reproduction unit 452 extracts a current sample of the enhancement layer, from the obtained MP4 file, and supplies the current sample to the enhancement layer decoding unit 454.

The processes of steps S459 and S460 are performed in a similar manner to the processes of steps S356 and S357 of FIG. 17. After the process of step S460, the process proceeds to step S463.

Furthermore, in step S452, when it is determined that there is no sample of the base layer corresponding to the current time (inter-layer prediction is not performed), the process proceeds to step S461.

The processes of steps S461 and S462 are performed in a similar manner to the processes of steps S358 and S359 of FIG. 17. After the process of step S462, the process proceeds to step S463.

In step S463, the MPD analysis unit 451 determines whether all samples are processed. When there is a sample not processed, the process returns to step S451, and the processes subsequent to step S451 are repeated. For each sample, the processes of steps S451 to S463 are repeated, and when it is determined that all samples are processed, in step S463, the file reproduction process ends.

Note that, when only decoding the base layer, the file reproduction device 450 preferably performs the processes of steps S453 to S555, and step S460 described above.

Since the file reproduction process is performed as described above, the file reproduction device 450 can timely decode the base layer (still image). That is, the file reproduction device 450 can correctly decode the encoded data obtained by hierarchically encoding a multi-layered image. In particular, even if the base layer has a still image without any time information, or even if the encoded data of the still image has an entity not stored in the MP4 file, the still image can be correctly decoded.

### 5. Fifth Embodiment

<Distribution System>

The above-mentioned devices according to the embodiments can be used, for example, for a distribution system for distributing still images or a moving image. The distribution system will be described below.

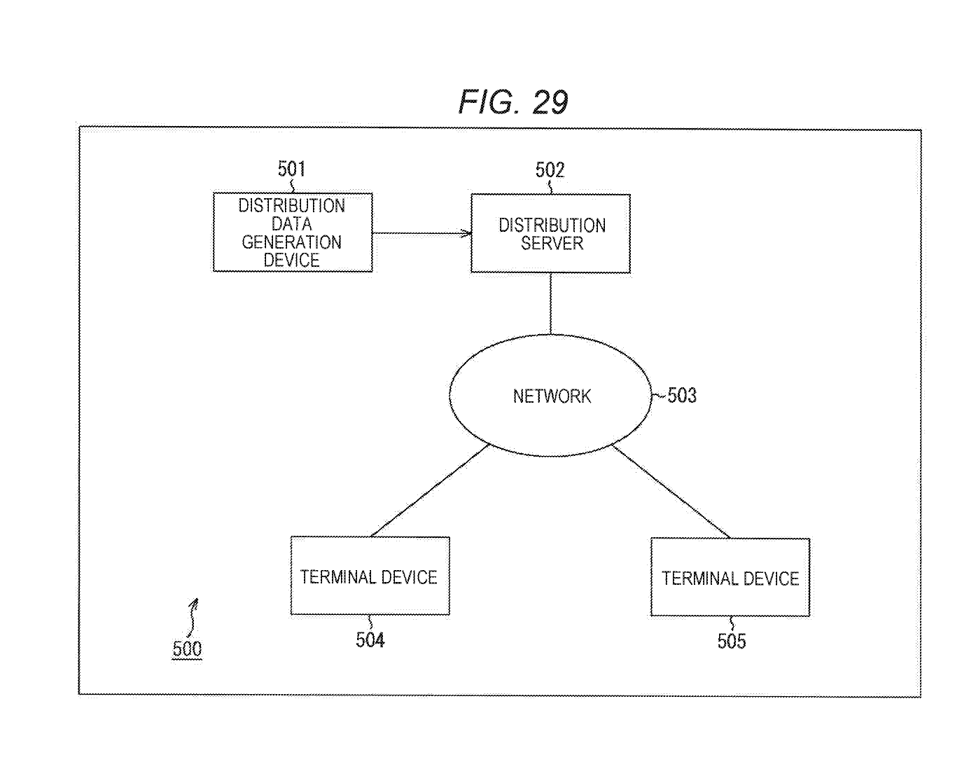

FIG. 29 is a diagram illustrating an exemplary main configuration of a distribution system to which the present technology is applied. The distribution system 500 illustrated in FIG. 29 is a system for distributing still images and a moving image. As illustrated in FIG. 29, the distribution system 500 has a distribution data generation device 501, a distribution server 502, a network 503, a terminal device 504, and a terminal device 505.

The distribution data generation device 501 generates distribution data having a distribution format, from data of the still images or moving image to be distributed. The distribution data generation device 501 supplies the generated distribution data to the distribution server 502. The distribution server 502 stores the distribution data generated by the distribution data generation device 501, in a storage unit or the like for management, and provides service for distributing the distribution data, to the terminal device 504 or the terminal device 505 through the network 503.

The network 503 is a communication network as a communication medium. The network 503 may be any communication network, that is, a wired communication network, a wireless communication network, or both of them. For example, a wired local area network (LAN), a wireless LAN, a public telephone network, wide area communication network for wireless mobile products such as so-called 3G network or 4G network, the Internet, or a combination thereof may be employed. Furthermore, the network 503 may be a single communication network, or a plurality of communication networks. Furthermore, for example, the network 503 may wholly or partially include a communication cable of predetermined standard, such as a universal serial bus (USB) cable or a high-definition multimedia interface (registered trademark) (HDMI) cable.

The distribution server 502, the terminal device 504, and the terminal device 505 are connected to the network 503, and communicable with each other. An arbitrary method is employed to connect them to the network 503. For example, these devices may be connected to the network 503 via wired communication or wireless communication. Furthermore, for example, these devices may be connected to the network 503 through an arbitrary communication device (communication facility), such as an access point, a relay device, or a base station.

The terminal device 504 and the terminal device 505 are each an arbitrary electronic device having a communication function, such as a cellular phone, a smartphone, a tablet computer, or a laptop computer. The terminal device 504 or the terminal device 505 makes a request to the distribution server 502 for distribution of a distribution file, for example on the basis of an instruction of the user.

The distribution server 502 transmits requested distribution data to a request source. The terminal device 504 or the terminal device 505 requesting the distribution thereof receives the distribution data and reproduces the distribution data.

In the distribution system 500 configured as described above, the present technology described in the above embodiments is applied to the distribution data generation device 501. That is, the above-mentioned MP4 file generation device 100, MP4 file generation device 200, MP4 file generation device 300, or file generation device 400 is used as the distribution data generation device 501.

Furthermore, the present technology described in the above embodiments is applied as the terminal device 504 or the terminal device 505. That is, the above-mentioned MP4 file reproduction device 150, MP4 file reproduction device 250, MP4 file reproduction device 350, or file reproduction device 450 is used as the terminal device 504 or the terminal device 505.

With such a configuration, the distribution data generation device 501, the terminal device 504, and the terminal device 505 can have similar effects to those of the above-mentioned embodiments. That is, the distribution system 500 can control the decoding time of encoded data obtained by hierarchically encoding a multi-layered image, and can achieve for example a function or service of the use case described in the first embodiment.

### 6. Sixth Embodiment

<Computer>

A series of processing described above may be executed by hardware or by software. For execution of the series of processing by the software, a program for constituting the software is installed on a computer. Here, the computer includes a computer incorporated into a dedicated hardware, or for example an all-purpose personal computer on which various programs are installed to perform various functions.

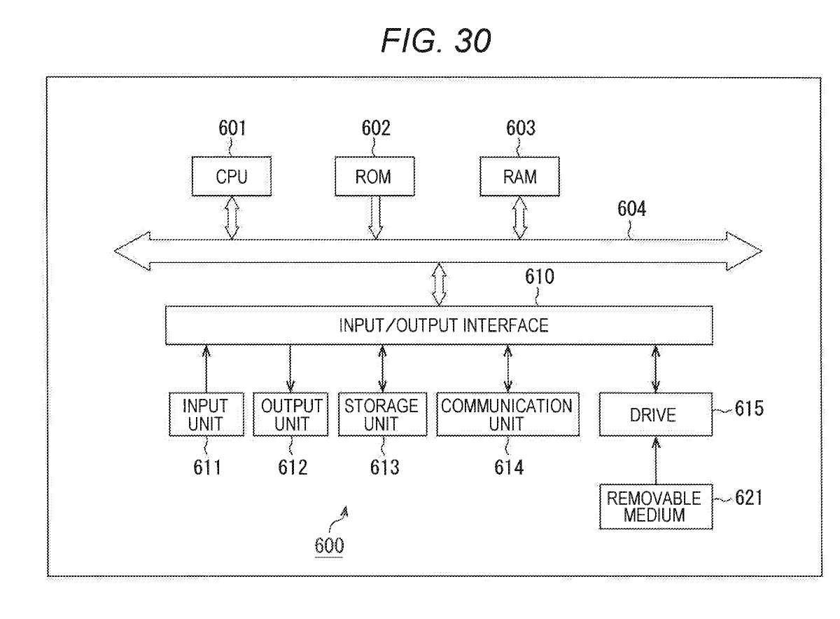

FIG. 30 is a block diagram illustrating an exemplary configuration of hardware of a computer performing the series of processing described above, using the program.

In the computer 600 illustrated in FIG. 30, a central processing unit (CPU) 601, a read only memory (ROM) 602, and a random access memory (RAM) 603 are connected to each other through a bus 604.

To the bus 604, an input/output interface 610 is also connected. To the input/output interface 610, an input unit 611, an output unit 612, a storage unit 613, a communication unit 614, and a drive 615 are connected.

The input unit 611 includes, for example, a keyboard, a mouse, a microphone, a touch panel, or an input terminal. The output unit 612 includes, for example, a display, a speaker, or an output terminal. The storage unit 613 includes, for example, a hard disk, a RAM disk, or a non-volatile memory. The communication unit 614 includes, for example, a network interface. The drive 615 drives a removable medium 621 such as a magnetic disk, an optical disk, a magnetooptic disk, or a semiconductor memory.

In the computer configured as described above, the CPU 601 loads, for example, a program stored in the storage unit 613, on the RAM 603, through the input/output interface 610 and the bus 604, for execution of the program, and the series of processing described above is performed. Furthermore, the RAM 603 also stores appropriate data or the like required for various processing executed by the CPU 601.

The program executed by the computer (CPU 601) can be applied by being stored, for example, in the removable medium 621 as a package media. In this configuration, the removable medium 621 can be mounted to the drive 615, to install the program in the storage unit 613 through the input/output interface 610 from.

Furthermore, the program can be provided through a wired or wireless transmission medium, such as a local area network, the Internet, or digital satellite broadcasting. In this configuration, the program can be received by the communication unit 614 and installed in the storage unit 613.

In addition, the program can be also installed in the ROM 602 or the storage unit 613 beforehand.

Note that, the program executed by the computer may be a program by which processes are performed chronologically in order as described in the present description, or may be a program by which processes are performed parallelly or at required time, for example, when called.

Furthermore, in the present description, a step of describing the program recorded in a recording medium includes not only processes performed chronologically in the described order, but also processes performed parallelly or individually, not necessarily chronologically.

Furthermore, the process of each step described above can be performed in each device described above, or in an arbitrary device other than the devices described above. In that case, the device performing the process preferably has a function (functional block etc.) required for performing the process, as described above. In addition, information required for the process is preferably transmitted to the device appropriately.

Furthermore, in the present description, the system represents an assembly of a plurality of component elements (devices, modules (parts) or the like), regardless of whether all component elements are in the same casing. Accordingly, a plurality of devices stored in separate casings and connected through a network, and one device storing a plurality of modules in one casing are defined as a system.

Furthermore, a configuration described above as one device (or processing unit) may be divided into a plurality of devices (or processing units). On the contrary, configurations described above as a plurality of devices (or processing units) may be assembled into one device (or processing unit). Further, as a matter of course, a configuration other than the above-mentioned configurations may be added to the configuration of each device (or each processing unit). Still further, as long as configurations or operations are substantially the same in the system as a whole, part of the configuration of a device (or processing unit) may be included in the configuration of another device (or another processing unit).

As described above, preferable embodiments of the present disclosure has been described in detail with reference to the accompanying drawings, but the technical scope of the present disclosure is not limited to these examples. A person having ordinary skill in the art may obviously find various alternations and modifications within the technical ideas as set forth in the scope of the appended claims, and it should be understood that they will naturally come under the technical scope of the present disclosure.

For example, the present technology can be configured as cloud computing in which one function is shared and cooperatively processed between multiple devices through a network.

Further, the steps described in the above-mentioned flowcharts can be performed by a single device, or performed to be shared between multiple devices.

Still further, when one step includes a plurality of processes, the plurality of processes included in the one step can be performed by a single device, or performed to be shared between multiple devices.

In addition, the present technology is not limited to the above description, and can be also implemented as any configuration mounted to the device or devices constituting the system, for example, a processor as a system large scale integration (LSI), a module using a plurality of processors, a unit using a plurality of modules, or a set obtained by further adding another function to the unit (i.e., partial configuration of the device).

Note that, the present technology can have a configuration as described below.

(1) An information processing device including

a file generation unit for generating a file storing encoded still image data obtained by encoding still images, and encoded moving image data obtained by encoding a moving image using prediction with reference to the still images, in different tracks, and

a time information setting unit for setting time information specifying decoding time of frames in a track of the file storing the encoded moving image data, and setting time information specifying decoding time of the still images, in a track storing the encoded still image data of the file, on the basis of a reference relationship between the still images and the moving image for the prediction, using the time information of the encoded moving image data.

(2) The information processing device according to (1), in which

the file generation unit stores, in the file, information indicating a storage location of the encoded still image data, instead of the encoded still image data.

(3) An information processing method including the steps of

generating a file storing encoded still image data obtained by encoding still images, and encoded moving image data obtained by encoding a moving image using prediction with reference to the still images,

setting time information specifying decoding time of frames in a track of the file storing the encoded moving image data, and

setting time information specifying decoding time of the still images, in a track storing the encoded still image data of the file, on the basis of a reference relationship between the still images and the moving image for the prediction, using the time information of the encoded moving image data.

(4) An information processing device including

a file reproduction unit reproducing a file storing encoded still image data obtained by encoding still images, and encoded moving image data obtained by encoding a moving image using prediction with reference to the still images, in different tracks, and extracting the encoded still image data and the encoded moving image data,

a still image decoding unit timely decoding the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction, and

a moving image decoding unit decoding the encoded moving image data extracted from the file timely on the basis of the time information specifying decoding time of frames of the encoded moving image data, with reference to the still images obtained by decoding the encoded still image data.

(5) An information processing method including the steps of

reproducing a file storing encoded still image data obtained by encoding still images, and encoded moving image data obtained by encoding a moving image using prediction with reference to the still images, in different tracks, to extract the encoded still image data and the encoded moving image data,

timely decoding the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction, and

timely decoding the encoded moving image data extracted from the file, on the basis of the time information specifying decoding time of frames of the encoded moving image data, with reference to the still images obtained by decoding the encoded still image data.

(6) An information processing device including

a file generation unit for generating a file storing encoded still image data obtained by encoding still images, and encoded moving image data obtained by encoding a moving image using prediction with reference to the still images, in different tracks; and

a table information generation unit for generating table information representing a reference relationship between the still images and the moving image for the prediction, and storing the table information in the file.

(7) The information processing device according to (6), in which

the file generation unit stores time information indicating display time of the still image, in the file.

(8) An information processing method including the steps of

generating a file storing encoded still image data obtained by encoding still images, and encoded moving image data obtained by encoding a moving image using prediction with reference to the still images, in different tracks, and

generating table information representing a reference relationship between the still images and the moving image for the prediction, and storing the table information in the file.

(9) An information processing device including

a file reproduction unit for reproducing a file storing encoded still image data obtained by encoding still images, and encoded moving image data obtained by encoding a moving image using prediction with reference to the still images, in different tracks, and extracting the encoded still image data and the encoded moving image data,

a still image decoding unit for timely decoding the encoded still image data extracted from the file, on the basis of time information specifying decoding time of frames of the encoded moving image data, and table information representing a reference relationship between the still images and the moving image for the prediction, and

a moving image decoding unit for timely decoding frames of the encoded moving image data extracted from the file, on the basis of the time information, with reference to the still images obtained by decoding the encoded still image data by the still image decoding unit.

(10) An information processing method including the steps of

reproducing a file storing encoded still image data obtained by encoding still images, and encoded moving image data obtained by encoding a moving image using prediction with reference to the still images, in different tracks, and extracting the encoded still image data and the encoded moving image data,

timely decoding the encoded still image data extracted from the file, on the basis of time information specifying decoding time of frames of the encoded moving image data, and table information representing a reference relationship between the still images and the moving image for the prediction, and

timely decoding frames of the encoded moving image data extracted from the file, on the basis of the time information, with reference to the still images obtained by decoding the encoded still image data by the still image decoding unit.

(11) An information processing device including

a time information generation unit for generating time information indicating decoding time of encoded still image data obtained by encoding still images, and time information indicating decoding time of frames of encoded moving image data obtained by encoding a moving image using prediction with reference to the still images, using a predetermined timeline, and

a metadata generation unit for generating metadata used for providing the encoded still image data and the encoded moving image data, using the time information.

(12) An information processing method including the steps of:

generating time information indicating decoding time of encoded still image data obtained by encoding still images, and time information indicating decoding time of frames of encoded moving image data obtained by encoding a moving image using prediction with reference to the still images, using a predetermined timeline, and

generating metadata used for providing the encoded still image data and the encoded moving image data, using the time information.

### REFERENCE SIGNS LIST

100 Mp4 File generation device
101 Base layer encoding unit
102 Enhancement layer encoding unit
103 Time information generation unit
104 MP4 file generation unit
150 MP4 file reproduction device
151 MP4 file reproduction unit
152 Time information analysis unit
153 Base layer decoding unit
154 Enhancement layer decoding unit
200 Mp4 File generation device
203 Time information generation unit
204 MP4 file generation unit
250 MP4 file reproduction device
252 Time information analysis unit
300 Mp4 File generation device
301 Base layer encoding unit
304 MP4 file generation unit
350 MP4 file reproduction device
351 MP4 file reproduction unit
353 Base layer decoding unit
400 File generation device
403 Time information generation unit
404 MP4 file generation unit
405 MPD generation unit
450 File reproduction device
451 MPD analysis unit
452 MP4 file reproduction unit
454 Enhancement layer decoding unit
500 Distribution system
501 Distribution data generation device
502 Distribution server
503 Network
504, 505 Terminal device
600 Computer

1. An information processing device comprising:
a file generation unit for generating a file storing encoded still image data obtained by encoding still images, and encoded moving image data obtained by encoding a moving image using prediction with reference to the still images, in different tracks; and
a time information setting unit for setting time information specifying decoding time of frames in a track of the file storing the encoded moving image data, and setting time information specifying decoding time of the still images, in a track storing the encoded still image data of the file, on the basis of a reference relationship between the still images and the moving image for the prediction, using the time information of the encoded moving image data.

2. The information processing device according to claim 1, wherein
the file generation unit stores, in the file, information indicating a storage location of the encoded still image data, instead of the encoded still image data.

3. An information processing method comprising the steps of:
generating a file storing encoded still image data obtained by encoding still images, and encoded moving image data obtained by encoding a moving image using prediction with reference to the still images, in different tracks;
setting time information specifying decoding time of frames in a track of the file storing the encoded moving image data; and
setting time information specifying decoding time of the still images, in a track storing the encoded still image data of the file, on the basis of a reference relationship between the still images and the moving image for the prediction, using the time information of the encoded moving image data.

4. An information processing device comprising:
a file reproduction unit for reproducing a file storing encoded still image data obtained by encoding still images, and encoded moving image data obtained by encoding a moving image using prediction with reference to the still images, in different tracks, and extracting the encoded still image data and the encoded moving image data;
a still image decoding unit for timely decoding the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction; and
a moving image decoding unit for decoding the encoded moving image data extracted from the file timely on the basis of the time information specifying decoding time of frames of the encoded moving image data, with reference to the still images obtained by decoding the encoded still image data.

5. An information processing method comprising the steps of:
reproducing a file storing encoded still image data obtained by encoding still images, and encoded moving image data obtained by encoding a moving image using prediction with reference to the still images, in different tracks, to extract the encoded still image data and the encoded moving image data;
timely decoding the encoded still image data extracted from the file on the basis of time information specifying decoding time of the still images, the time information specifying decoding time of the still images being set using time information specifying decoding time of frames of the encoded moving image data on the basis of a reference relationship between the still images and the moving image for the prediction; and
timely decoding the encoded moving image data extracted from the file, on the basis of the time information specifying decoding time of frames of the encoded moving image data, with reference to the still images obtained by decoding the encoded still image data.

6. An information processing device comprising:
a file generation unit for generating a file storing encoded still image data obtained by encoding still images, and encoded moving image data obtained by encoding a moving image using prediction with reference to the still images, in different tracks; and
a table information generation unit for generating table information representing a reference relationship between the still images and the moving image for the prediction, and storing the table information in the file.

7. The information processing device according to claim 6, wherein
the file generation unit stores time information indicating display time of the still image, in the file.

8. An information processing method comprising the steps of:
generating a file storing encoded still image data obtained by encoding still images, and encoded moving image data obtained by encoding a moving image using prediction with reference to the still images, in different tracks; and
generating table information representing a reference relationship between the still images and the moving image for the prediction, and storing the table information in the file.

9. An information processing device comprising:
a file reproduction unit for reproducing a file storing encoded still image data obtained by encoding still images, and encoded moving image data obtained by encoding a moving image using prediction with reference to the still images, in different tracks, and extracting the encoded still image data and the encoded moving image data;
a still image decoding unit for timely decoding the encoded still image data extracted from the file, on the basis of time information specifying decoding time of frames of the encoded moving image data, and table information representing a reference relationship between the still images and the moving image for the prediction; and
a moving image decoding unit for timely decoding frames of the encoded moving image data extracted from the file, on the basis of the time information, with reference to the still images obtained by decoding the encoded still image data by the still image decoding unit.

10. An information processing method comprising the steps of:
reproducing a file storing encoded still image data obtained by encoding still images, and encoded moving image data obtained by encoding a moving image using prediction with reference to the still images, in different tracks;
extracting the encoded still image data and the encoded moving image data;
timely decoding the encoded still image data extracted from the file, on the basis of time information specifying decoding time of frames of the encoded moving image data, and table information representing a reference relationship between the still images and the moving image for the prediction; and
timely decoding frames of the encoded moving image data extracted from the file, on the basis of the time information, with reference to the still images obtained by decoding the encoded still image data by the still image decoding unit.

11. An information processing device comprising:
a time information generation unit for generating time information indicating decoding time of encoded still image data obtained by encoding still images, and time information indicating decoding time of frames of encoded moving image data obtained by encoding a moving image using prediction with reference to the still images, using a predetermined timeline; and
a metadata generation unit for generating metadata used for providing the encoded still image data and the encoded moving image data, using the time information.

12. An information processing method comprising the steps of:
generating time information indicating decoding time of encoded still image data obtained by encoding still images, and time information indicating decoding time of frames of encoded moving image data obtained by encoding a moving image using prediction with reference to the still images, using a predetermined timeline; and
generating metadata used for providing the encoded still image data and the encoded moving image data, using the time information.
